(19) United States
(12) Patent Application Publication
(10) Pub. No.: US 2026/0331092 A1
(43) Pub. Date: Oct. 22, 2026

(54) METHOD AND DEVICE FOR DYNAMICALLY OUTPUTTING MULTIPLE AUDIO

(71) Applicants: Hyundai Motor Company, Seoul (KR); Kia Corporation, Seoul (KR)

(72) Inventors: Sung Bum HONG, Hwaseong-Si (KR); Chang Woo Chun, Hwaseong-Si (KR); Seong Soo Yae, Hwaseong-Si (KR); Yun Il Hwang, Hwaseong-Si (KR)

(73) Assignees: Hyundai Motor Company, Seoul (KR); Kia Corporation, Seoul (KR)

(21) Appl. No.: 19/410,367

(22) Filed: Dec. 5, 2025

(30) Foreign Application Priority Data
Apr. 16, 2025 (KR) 10-2025-0049494

(51) Int. Cl. G10L 13/04; G06F 3/16; G06F 40/205; G06F 40/253; G11B 27/34

(52) U.S. Cl. CPC G10L 13/04; G06F 3/165; G06F 40/205; G06F 40/253; G11B 27/34

(57) ABSTRACT

In a method and a device for dynamically outputting multiple audios, the method includes dividing a text script or a first audio into multiple chunks based on a first time point at which a playback of the first audio is to start, a second time point at which a playback of a second audio is to start, or a combination of the first time point and the second time point, wherein the first audio is audio synthesized or to be synthesized based on the text script and the second audio has a higher priority than the first audio, and non-consecutively outputting speech signals corresponding to the multiple chunks such that a first playback time ranges corresponding to the multiple chunks does not overlap with a second playback time range of the second audio.

### CROSS-REFERENCE TO RELATED APPLICATIONS

The present application is based on, and claims priority from, Korean Patent Application Number 10-2025-0049494, filed Apr. 16, 2025, the present disclosure of which is incorporated by reference herein in its entirety.

### FIELD OF THE PRESENT DISCLOSURE

The present disclosure relates to a method and a device for dynamically outputting multiple audios.

### BACKGROUND

The statements in this section merely provide background information related to the present disclosure and do not necessarily constitute prior art.

In the field of vehicles, sound-based user interfaces are increasingly being utilized as a means to reduce the visual burden on users, e.g., the driver or passenger, and increase the intuitiveness of information delivery. Users can receive a variety of information in real-time via sound output without having to look at visual information. For example, vehicles can provide GPS navigation guidance, traffic conditions, vehicle status alerts, warning messages, call notifications, and other information through sound to minimize distractions and help maintain focus while driving. Recent advances in text generation and speech synthesis technologies have also enabled to output a variety of text generated in real time in natural-sounding speech, increasing the variety of sound-based interactions between vehicles and users.

### BRIEF SUMMARY

According to various aspects of the present disclosure, the present disclosure provides a method performed by a computing device, the method including dividing a text script or a first audio into multiple chunks, based on a first time point at which a playback of the first audio is to start, a second time point at which a playback of a second audio is to start, or a combination of the first time point and the second time point, wherein the first audio is audio synthesized or to be synthesized based on the text script and the second audio has a higher priority than the first audio; and non-consecutively outputting speech signals corresponding to the multiple chunks, such that first playback time ranges corresponding to the multiple chunks do not overlap with a second playback time range of the second audio

According to various aspects of the present disclosure, the present disclosure provides an apparatus including a memory configured to store instructions, and at least one processor. The at least one processor executing the instructions is configured to divide a text script or a first audio into multiple chunks, based on a first time point at which a playback of the first audio is to start, a second time point at which a playback of a second audio is to start, or a combination of the first time point and the second time point, wherein the first audio is audio synthesized or to be synthesized based on the text script and the second audio has a higher priority than the first audio; and to non-consecutively output speech signals corresponding to the multiple chunks, such that first playback time ranges corresponding to the multiple chunks do not overlap with a second playback time range of the second audio.

According to various aspects of the present disclosure, the present disclosure provides a vehicle including a driver assistance system configured to generate a first audio for assisting a driver, or a first text script for synthesizing the first audio, and a speech processing device. The speech processing device is configured to divide a second text script or a second audio into multiple chunks, based on a first time point at which a playback of the first audio is to start, a second time point at which a playback of the second audio that has a higher priority than the first audio is to start, or a combination of the first time point and the second time point, wherein the second audio is audio synthesized or to be synthesized based on the second text script and has a lower priority than the first audio; and to non-consecutively output speech signals corresponding to the multiple chunks, such that first playback time ranges corresponding to the multiple chunks do not overlap with a second playback time range of the second audio.

### BRIEF DESCRIPTION OF THE DRAWINGS

FIG. 1 is a schematic block diagram illustrating a vehicle according to at least an exemplary embodiment of the present disclosure.

FIG. 2A and FIG. 2B are diagrams illustrating the operation of a speech processing device according to various exemplary embodiments of the present disclosure.

FIG. 3A and FIG. 3B are diagrams illustrating the operation of scheduling a playback time of a speech response, according to various exemplary embodiments of the present disclosure.

FIG. 4A, FIG. 4B and FIG. 4C are diagrams illustrating the operation of rescheduling the playback time of a speech response, according to various exemplary embodiments of the present disclosure.

FIG. 5 is a diagram illustrating the operation of generating a speech response including a bridge voice, according to at least an exemplary embodiment of the present disclosure.

FIG. 6A and FIG. 6B are diagrams illustrating the operation of restructuring the content of a speech response, according to various exemplary embodiments of the present disclosure.

FIG. 7 is a flowchart of a method for speech response processing triggered by a driver assistance audio notice, according to at least an exemplary embodiment of the present disclosure.

FIG. 8 is a flowchart of a response reprocessing process according to at least an exemplary embodiment of the present disclosure.

FIG. 9 is a flowchart of a method for speech response processing triggered by a driver assistance audio interrupt, according to at least an exemplary embodiment of the present disclosure.

FIG. 10 is a flowchart of a method of dynamically outputting audios, according to at least an exemplary embodiment of the present disclosure.

FIG. 11 is a block diagram schematically illustrating an example vehicle system that can be used to implement the method or apparatus according to embodiments of the present disclosure.

FIG. 12 is a schematic diagram of an illustrative configuration of a computing device that may be used to implement the methods and apparatuses described herein.

### DETAILED DESCRIPTION

The present disclosure may provide a method and a device for dynamically outputting multiple audio streams generated from different domains in a vehicle.

The present disclosure may provide a method and a device for avoiding conflicts between a speech response to a user request and the other domain's audio outputs.

The present disclosure may provide a method and a device for alternately outputting a speech response and the other domain's audio outputs while preventing a user from losing the context of the speech response.

The present disclosure may provide a method and a device for outputting a natural language response generated by using generative artificial intelligence (AI) in the form of speech without interfering with the output of audio that has a higher priority than the response.

The features of the present disclosure are not limited to those particularly described hereinabove, and the above and other features that the present disclosure can achieve will be clearly understood by those skilled in the art from the following detailed description.

Hereinafter, various exemplary embodiments of the present disclosure will be described in detail with reference to the accompanying drawings. In the following description, like reference numerals preferably designate like elements, although the elements are shown in different drawings. Furthermore, the following description of various exemplary embodiments will omit for the purpose of clarity and for brevity, a detailed description of related known components and functions when considered to obscure the subject of the present disclosure.

Various ordinal numbers or alpha codes, such as first, second, i), ii), a), b), etc., are prefixed solely to differentiate one component from the other but not to imply or suggest the substances, order, or sequence of the components. Throughout this specification, when a part ‘includes’ or ‘comprises’ a component, the part is meant to further include other components, to not exclude thereof unless specifically stated to the contrary.

The following detailed description, along with the accompanying drawings, is intended to illustrate exemplary embodiments of the present disclosure and is not intended to represent the only embodiments in which the present disclosure may be practiced.

As used herein, the term ‘and/or’ includes any combination of the plurality of listed items or any of the plurality of listed items. As used herein, the term ‘A or B’ may include ‘A’, ‘B’, or ‘both A and B’.

In the present disclosure, the term “engine” may be used broadly to refer to a software-based system, subsystem, or process that is programmed to perform one or more specific functions. An engine may be implemented as one or more software modules or components that are installed on one or more computing devices at one or more locations. In some examples, one or more computing devices may be dedicated to a particular engine, or in other examples, multiple engines may be executed on the same computing device or computing devices.

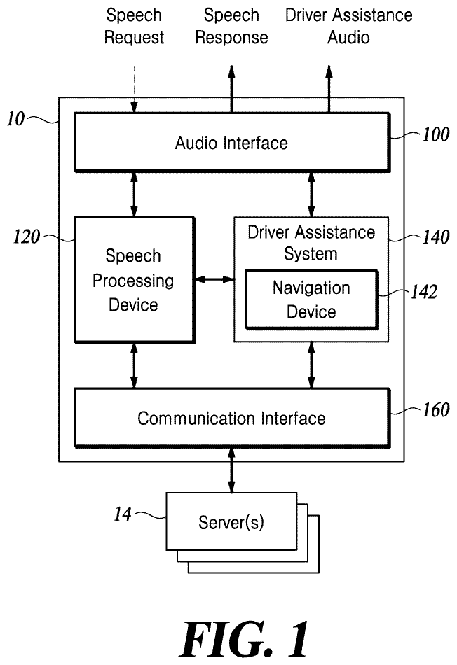

FIG. 1 is a schematic block diagram illustrating a vehicle according to at least an exemplary embodiment of the present disclosure.

The vehicle 10, according to at least an exemplary embodiment of the present disclosure, may include all or some of an audio interface 100, a speech processing device 120, a driver assistance system 140, and a communication interface 160. Not all of the blocks illustrated in FIG. 1 are requisite components, and some blocks may be added, changed, or deleted in other exemplary embodiments. Furthermore, the components illustrated in FIG. 1 represent functionally distinct components, and at least one or more of the components may be implemented in an integrated form between them in an actual physical environment.

The audio interface 100 may receive sound information from within or outside of the vehicle 10, or output sound information to or from within or outside of the vehicle 10. The audio interface 100 may include one or more microphones and/or one or more speakers. The audio interface 100 may receive a speech request from a user, e.g., a driver or passenger, and may output a speech response to the user's inputted request. The speech request and the speech response may include a question and an answer thereto. Additionally or alternatively, the audio interface 100 may output audio such as voice guidance or voice prompts, alerts, multimedia content, and the like. In addition, the audio interface 100 may operate in conjunction with an in-vehicle infotainment system to input and output various audio data.

The speech processing device 120 may process sound information inputted via the audio interface 100 to convert the sound information into a comprehensible form and/or generate information for a response. The speech processing device 120 may analyze a speech request inputted by the user and generate a speech response corresponding to the request. The speech processing device 120 may control the generated speech response to be outputted via the audio interface 100. The speech processing device 120 may control the speech response and audio from other components within the vehicle 10, such as the driver assistance system 140 to be dynamically and alternately outputted.

The driver assistance system 140 may perform a variety of functions to improve the driving safety of the vehicle and increase the comfort of the driver. The driver assistance system 140 may output various sound information to assist the user in driving, which may be referred to as driver assistance audio. The driver assistance audio may be outputted in the form of voice prompts, and may also be provided in the form of warning or notification sounds depending on the situation.

The driver assistance system 140 may include a navigation device 142. The navigation device 142 may determine the current location of the vehicle 10 and may provide the user with directions to a destination. The navigation device 142 may utilize road traffic information, map data, real-time location information, and the like to determine an appropriate route during driving and provide the route to the user. The navigation device 142 may also operate in conjunction with the speech processing device 120 and/or the audio interface 100 to provide voice-based route guidance to the user.

The driver assistance audio may include information about various driving situations in addition to navigation guidance. For example, the driver assistance system 140 may provide information to the user via the driver assistance audio, such as forward collision warnings, lane departure warnings, speed limit reminders, cautionary instructions for results of recognizing stop signs or traffic lights, and the like. The audio may be in the form of a voice, a warning sound, a notification sound, or the like, depending on the urgency or importance of the situation.

The vehicle 10 may transmit and receive data to and from external systems via the communication interface 160. For example, the vehicle 10 may be linked with one or more servers 14 via the communication interface 160. The servers 14 may include an intelligent transportation system (ITS) server and/or an inference server for artificial intelligence computation. The inference server may perform functions such as, for example, speech recognition, text generation, and/or speech synthesis. The inference server may operate in conjunction with the speech processing device 120 in the vehicle 10 to support natural language-based request processing or response generation.

The communication interface 160 may employ at least one of various wireless communication schemes, such as cellular communication (e.g., 4G, 5G) and/or short-range wireless communication (e.g., Bluetooth, Wi-Fi), to transmit and receive data to and from the server 14. Additionally or alternatively, the communication interface 160 may also transmit and receive data to and from an external device via a wired interface, such as a universal serial bus (USB) port, an auxiliary (AUX) port, etc.

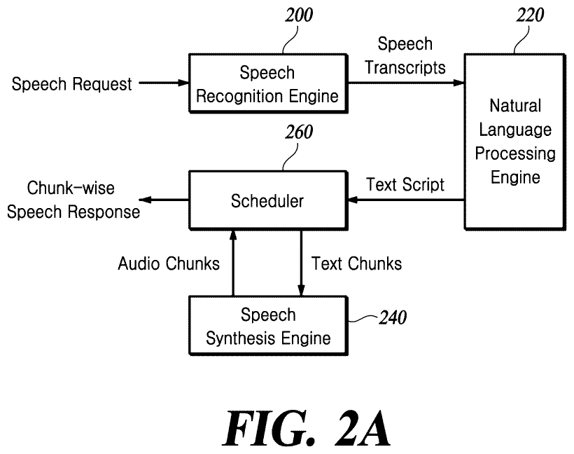

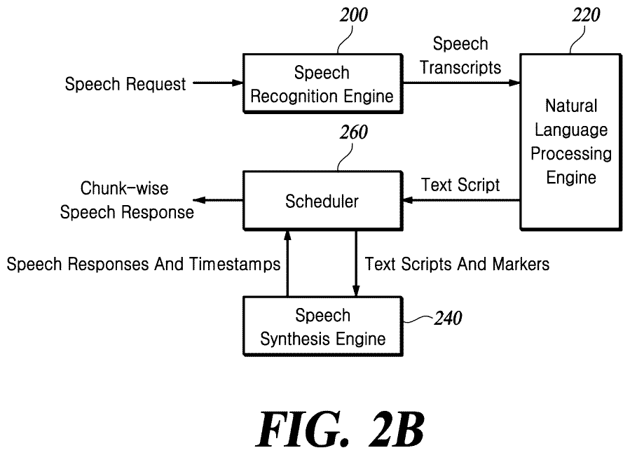

FIG. 2A and FIG. 2B are diagrams illustrating the operation of the speech processing device 120 according to various exemplary embodiments of the present disclosure.

The speech processing device 120 may include all or some of a speech recognition engine 200, a natural language processing engine 220, a speech synthesis engine 240, and a scheduler 260. In some examples, at least some of the functions of the speech processing device 120 may be distributed and processed on the server 14. For example, the computationally intensive processing of the natural language processing engine 220 may be performed by the server 14, but the present disclosure is not limited to such an example.

The speech recognition engine 200 may convert a speech request to text and generate a speech transcript. In some examples, the speech recognition engine 200 may be referred to as a Speech to Text (STT) engine.

The speech request processed by the speech recognition engine 200 may include a speech signal that is a record of the user's speech. For example, the audio interface 100 may receive the user's speech as an analog signal, convert it to a digital speech signal, and provide the digital speech signal to the speech recognition engine 200. The speech recognition engine 200 may perform processes such as preprocessing based on the speech signal and feature extraction to generate a speech transcript. The speech recognition engine 200 may apply various speech recognition algorithms and/or deep learning models to the speech signal to convert the same into text.

The natural language processing engine 220 may generate a text transcript based on the speech transcript. In some examples, instead of the speech transcript, separate text input may be provided to the natural language processing engine 220. For example, a user may enter text via an in-vehicle touchscreen display or select a particular text from a variety of candidate texts displayed. As another example, preset commands or standardized command templates that are pre-registered by the user may be provided to the natural language processing engine 220. The various text inputs including the speech transcript and/or separate text input to the natural language processing engine 220 may be referred to as request text, and the text generated based on the request text may be referred to as response text.

In some examples, the natural language processing engine 220 may utilize a generative model to generate the response text for a given request text. The generative model may be an artificial intelligence model trained to perform various natural language generation tasks. For example, the generative model may perform at least the following tasks: a response-to-query task for generating answers to user questions, a text summarization task for summarizing inputted text, a sentence or document generation task based on a specified topic or style, a sentence correction task for improving the quality of a sentence or document, a paraphrasing task for replacing an original expression with another expression while preserving the meaning of the original expression, or a machine translation task. In some examples, the generative model may be a large language model (LLM) trained with a large dataset. For example, the generative model may be, but is not limited to, a model of the transformer family. In some examples, the natural language processing engine 220 may include a dialog management function of the interactive system, or may perform response-to-query functions in conjunction with an external knowledge base.

The speech synthesis engine 240 may generate a speech response based on the text script. In some examples, the speech synthesis engine 240 may be referred to as a Text to Speech (TTS) engine.

The speech synthesis engine 240 may apply prosody, phonetic information, intonation, and the like to an inputted text script to generate a human-like natural-sounding speech signal. For example, the speech synthesis engine 240 may use one or more of waveform concatenation, statistical parametric synthesis, or neural network-based text-to-speech (neural TTS). For example, the speech synthesis engine 240 may utilize a deep learning-based TTS model to generate speech responses. The TTS model may be, for example, but not limited to, a flow, transform, and/or convolution-based model.

The generated speech response may be outputted via the audio interface 100 to be provided audibly to the user. The speech response may be used for prompting messages, warning notifications, answering questions, command confirmations, and the like. For example, a user may hear, from the system via a speech response, information such as route guidance, alerts about system status, responses to queries, or results of executing commands.

In some examples, audios generated from various domains may be outputted within the vehicle 10. As used herein, a domain may refer to a functional or service processing unit performed by an in-vehicle system. For example, a driver assistance domain may include various functions to enhance the driving safety and driving comfort of the vehicle. There may be an infotainment domain, a voice interaction domain, a vehicle status monitoring domain, and the like, each of which may independently generate speech or audio output, or may request speech synthesis from the speech synthesis engine 240.

The scheduler 260 may prevent output conflicts between different domains' audios from the voice interaction domain of the speech processing device 120 and other domains by controlling the data flow between the natural language processing engine 220 and the speech synthesis engine 240 and/or the timing of the output of synthesized speech. The scheduler 260 may prioritize audio from the voice interaction domain and audios from other domains.

Table 1 and Table 2 show examples of responses to queries in the voice interaction domain.

TABLE 1

| | |
|---|---|
| Question | How is the weather today? |
| Answer | It's chilly in Seoul today. Though temperatures will rise to |
| | around 20 degrees Celsius during the day, the morning and |
| | evening temperatures may drop below 10 degrees. Because |
| | temperature varies much, it's good to dress accordingly. |
| | This is a particularly cold day of the season, and morning |
| | dew or frost is expected so be mindful when going out. |

TABLE 2

| | |
|---|---|
| Question | I have a sore throat. What medications should I take? |
| Answer | It's important to identify symptoms and choose the right medication |
| | for sore throat. A sore throat may be caused by a cold, tonsillitis, or |
| | sphagitis. Depending on your symptoms, medications to consider |
| | include: First, pain relievers and fever reducers to relieve sore throat |
| | pain and, if accompanied by a fever. For example, acetaminophen |
| | commonly known by Tylenol, is effective at relieving pain and fever. |
| | And ibuprofen that is Advil, or Burupen, also have anti-inflammatory |
| | properties, which are especially good for pain caused by inflammation. |
| | Next up are throat sprays or lozenges, which can help relieve throat |
| | discomfort directly. Throat sprays are used against a sore throat, |
| | and spraying a product that contains a local anesthetic can help |
| | reduce the pain in your throat. Throat lozenges, also called troches, |
| | can help keep your throat moisturized and have a mild analgesic |
| | effect, which is helpful if you have a sore or scratchy throat. |
| | And if you have a bacterial infection, such as tonsillitis or sphagitis, |
| | you may need antibiotics. Antibiotics require doctor's prescription. |
| | In general, you can first try pain relievers, throat lozenges, or |
| | sprays to relieve symptoms, and if symptoms become severe |
| | or persist, you should visit a doctor for a diagnosis. |

A speech response to a user's query typically has a longer duration than audios from other domains, e.g., than navigation voice prompts. If prioritization between audios is not established, the output of other audios may be blocked while the speech response is being outputted. This may result in the driver not hearing important route guidance to the destination, speeding warnings, etc., that are critical for driving, which may put the driver in a dangerous situation, such as deviating from the route or violating the law.

The scheduler 260 may give driver assistance audio generated by the driver assistance domain a higher priority than a speech response to a user query. The scheduler 260 may pause the output of the speech response when the output of the driver assistance audio is scheduled to occur, and may resume the output of the speech response after the end of the output of the driver assistance audio.

Table 3 shows an example of a speech response in the voice interaction domain being outputted alternately with a driver assistance audio. For ease of identification, the driver assistance audio portion is separated by square brackets.

TABLE 3

| | |
|---|---|
| Output | It's chilly in Seoul today. Though temperatures will rise to |
| Audio | around 20 degrees Celsius during the day, the morning and |
| | evening temperatures [Take the right exit after 300 meters.] may |
| | drop below 10 degrees. Because temperature varies much, it's |
| | good to dress accordingly. This is a particularly cold day of the |
| | season, and morning dew or frost is expected so be mindful |
| | when going out. |

As shown in the example in Table 3, if the outputs are simply alternated without considering the contents of the cross-domain audios, the user may miss the context of the audio that was previously being outputted.

To facilitate the user's understanding of the context of the existing domain during domain-to-domain alternation, the scheduler 260 may divide the content of the response into units of chunks of humanly understandable size and allocate playback time by units of divided chunks. For example, each chunk may include one or more semantic units or one or more syntactic units. A semantic unit may represent a unit in a sentence, which can be understood as a single concept, meaning, or piece of information. A syntactic unit is a unit of grammatical structure, which may include a word or phrase, clause, sentence, etc. To identify boundaries between semantic units or syntactic units, the scheduler 260 may utilize grammatical markers contained within the text script. The grammatical markers may include punctuation, connective endings, and/or connectives. A punctuation may include terminators (e.g., a period, question mark, exclamation point, etc.) and delimiters, e.g., a comma, colon, semicolon, dash, etc.

The scheduler 260 may assign tiers or levels based on types of grammatical markers, and may divide a response hierarchically (or in stages). For example, terminators may be defined as grammatical markers in a first level, delimiters may be defined as grammatical markers in a second level, and connective endings or connectives may be defined as grammatical markers in a third level. The scheduler 260 may prioritize searching of a higher level (e.g., the first level or the second level), and only perform searching of a lower level (e.g., the second level or the third level) if a suitable dividing location (i.e., a boundary between chunks) has not been identified in that higher level. For example, the scheduler 260 may attempt to divide the response based on the terminator and, if subdividing is required, may attempt to divide based on the delimiters. When further subdivision is required, the scheduler 260 may utilize connective endings or connectives.

The segmentation of the response may be done at the text level. For example, referring to FIG. 2A, the scheduler 260 may divide a text script into a plurality of text chunks by taking into account a predicted time point when another audio is to be outputted that has a higher priority than the speech response. The scheduler 260 may input each text chunk into the speech synthesis engine 240 to obtain audio chunks corresponding to each text chunk. The scheduler 260 may request the speech synthesis engine 240 for speech synthesis in real time at the time each audio chunk needs to be played, and/or may output pre-synthesized audio chunks at scheduled times. For example, while driver assistance audio is being outputted, the scheduler 260 may pre-synthesize and store audio chunks that need to be outputted at a later time.

Additionally or Alternatively, the segmentation of the response may also occur at the audio level. For example, referring to FIG. 2B, the scheduler 260 may provide the speech synthesis engine 240 with the text script, along with markers representing all candidate boundaries that may divide the text script, and obtain from the speech synthesis engine 240 a synthesized speech response for the entire text script and a timestamp corresponding to each marker. The scheduler 260 may identify among timestamps a reference timestamp to be used for dividing the speech response, based on the predicted time point when the other audio is to be outputted that has a higher priority than the speech response. The scheduler 260 may stop outputting the speech response at the identified reference timestamp and resume outputting the speech response after the other audio has ended.

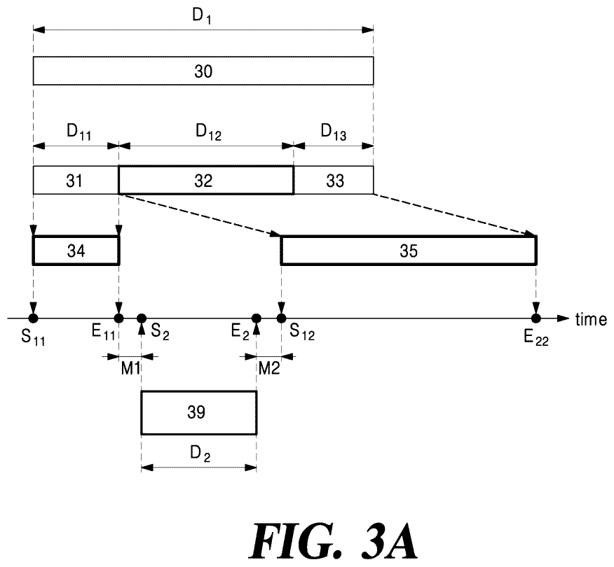

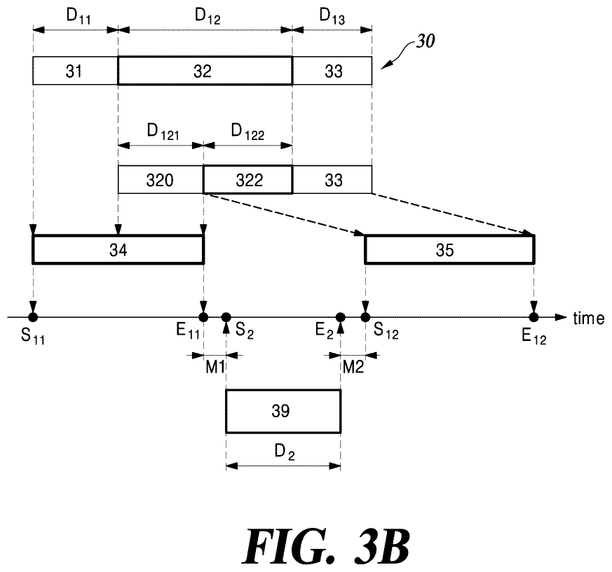

Referring now to FIGS. 3A, 3B, 4A, 4B, 4C, 5, 6A and 6B, examples are described in which the scheduler 260 processes a response and assigns a playback time. The following description assumes that the response is a generative model's generated answers to user questions, and audio from the other domain is assumed to be driver assistance audio, e.g., voice prompts or audio warnings, etc., caused by the driver assistance system 140, but the present disclosure is not so limited. For example, the technical ideas of the present disclosure may be applied to other media content, such as radio or podcasts.

FIG. 3A and FIG. 3B are diagrams illustrating the operation of scheduling a playback time of a speech response, according to various exemplary embodiments of the present disclosure.

FIG. 3A illustrates an example of segmenting a response 30, which includes a first candidate chunk 31 with a first sentence, a second candidate chunk 32 with a second sentence, and a third candidate chunk 33 with a third sentence, into multiple chunks 34 and 35 based on the first-level grammatical markers which are located between sentence and assigning a playback time for each chunk 34 and 35.

The scheduler 260 may identify possible conflicts between the speech response 30 and the driver assistance audio 39 based on a start time point S₁₁ for the speech response 30 to be played, a duration D₁ of the speech response 30, a start time point S₂ for the driver assistance audio 39 to be played, and/or a duration D₂ of the driver assistance audio 39. For example, the scheduler 260 may estimate, based on the playback start time point S₁₁ and duration D₁ of the speech response 30, a playback time range [S₁₁, S₁₁+D₁] for the speech response 30 to be played, and may estimate, based on the playback start time point S₂ and duration D₂ of the driver assistance audio 39, a playback time range [S₂, S₂+D₂] for the driver assistance audio 39 to be played. Based on whether the two time ranges overlap, the scheduler 260 may identify possible conflicts between the audios.

The playback start time point S₁₁ of the speech response 30 may be, for example, a time when the text script is obtained from the natural language processing engine 220, plus a delay of a predetermined buffering time. The buffering time may include, for example, a pre-loading time required to pre-synthesize some of the text script. The scheduler 260 may estimate the duration D₁ of the speech response 30 based on the number of characters in the text script, or may obtain the duration D₁ of the speech response from the speech synthesis engine 240. The scheduler 260 may periodically or aperiodically receive from the driver assistance system 140 the playback start time point S₂ and the duration D₂ of the driver assistance audio 39. In some examples, the scheduler 260 may receive text corresponding to the driver assistance audio 39 from the driver assistance system 140 and use it to directly estimate the duration D₂ of the driver assistance audio 39.

If a conflict between audios is scheduled, the scheduler 260 may identify candidate boundaries between chunks based on terminators included in the text script. For example, the scheduler 260 may divide the text script based on terminators to form a plurality of candidate chunks 31, 32 and 33 of a sentence unit. Based on the durations D₁₁, D₁₂, and D₁₃ of the respective sentences, the scheduler 260 may estimate playback time ranges [S₁₁, S₁₁+D₁₁], [S₁₁+D₁₁, S₁₁+D₁₁+D₁₂], and [S₁₁+D₁₁+D₁₂, S₁₁+D₁] for the respective chunks 31, 21 and 22 to be played.

Table 4 shows an example of dividing the example response in Table 1 based on terminators.

TABLE 4

| Time Range | Candidate Chunk |
|---|---|
| 0~2 (2s) | It's chilly in Seoul today. |
| 2~8 (6s) | Though temperatures will rise to around 20 degrees |
| | Celsius during the day, the morning and evening |
| | temperatures may drop below 10 degrees. |
| 8~12 (4s) | Because temperature varies much, it's good to dress |
| | accordingly. |
| 12~19 (7s) | This is a particularly cold day of the season, and morning |
| | dew or frost is expected so be mindful when going out. |

The scheduler 260 may identify, from the plurality of candidate chunks 31, 32 and 33, a target candidate chunk that has an overlapping playback time range with the driver assistance audio 39. In the example of FIG. 3A, the second candidate chunk 32 containing the second sentence may be determined as a target candidate chunk. If there are multiple candidate chunks with overlapping playback time ranges, the earliest candidate chunk may be identified as the target candidate chunk. The scheduler 260 may group the candidate chunk(s) 31 preceding the target candidate chunk 32 into a single chunk 34, group the target candidate chunk 32 and its following candidate chunk(s) 33 into a single chunk 35, and assign non-contiguous playback time ranges [S₁₁, E₁₁] and [S₁₂, E₁₂] to the two grouped chunks 34 and 35. In other words, a temporal gap may be intentionally inserted between a playback end time point E₁₁ of the preceding chunk 34 and a playback start time point S₁₂ of the second chunk 35. For example, the preceding chunk 34 may start to play from the existing playback start time point S₁₁, and the following chunk 35 may start to play from the time point S₁₂ after the end of playback of the driver assistance audio 39.

The scheduler 260 may insert predetermined margin times M1 and M2 between the chunks 34 and 35 and the driver assistance audio 39. For example, the playback start time point S₁₂ of the second chunk 35 may be determined such that the second chunk 35 is played after the predetermined margin time M2 from the playback end time point E₂ of the driver assistance audio 39.

Additionally or alternatively, the scheduler 260 may divide the chunks 34 and 35 such that a temporal gap exists between the playback end time point E₁₁ of the preceding first chunk 34 and the playback start time point S₂ of the driver assistance audio 39. For example, the playback start time point S₂ of the driver assistance audio 39 may be later than the playback start time of the second candidate chunk and the playback start time of the third candidate chunk. Even then, if a temporal gap less than a predetermined threshold margin time is interposed between the playback start time point S₂ of the driver assistance audio 39 and the playback stop time of the second candidate chunk, the scheduler 260 may divide the chunks based on the playback start time point of the second candidate chunk, rather than the playback start time point of the third candidate chunk.

Additionally or alternatively, the scheduler 260 may work in conjunction with the server 14 to dynamically determine the chunking points of the response 30 and the durations of the predetermined margin times M1 and M2. For example, if the vehicle 10 is stopped due to a stop sign at a traffic light, the scheduler 260 may receive, from the ITS server, the remaining time of the stop sign and factor the same into the chunking and margin time determinations.

The scheduler 260 may dynamically determine the durations of the predetermined margin times M1 and M2 based on the current speed of the vehicle 10. For example, a slower vehicle speed may result in a longer margin time setting, and a faster vehicle speed may result in a shorter margin time setting.

By designing the predetermined margin times M1 and M2 in this manner, the scheduler 260 may assign playback times that are robust to changes in vehicle speed. For example, if a change in the speed of the vehicle 10 causes the playback start time point S₂ of the driver assistance audio to change but remain in the predetermined margin times M1 and M2, then no conflict would occur between the driver assistance audio 39 and the chunks 34 and 35.

Table 5 shows an example of alternately outputting a speech response 30 and the driver assistance audio 39 in sentence units when the playback start time point S₂ of the driver assistance audio 39 is later than the playback end time point of the first candidate chunk and earlier than the playback end time of the second candidate chunk.

TABLE 5

| Time Range | Output Audio |
|---|---|
| 0~2 (2s) | It's chilly in Seoul today. |
| 2~3 (1s) | (Margin) |
| 3~6 (3s) | [Take the right exit after 300 meters.] |
| 6~7 (1s) | (Margin) |
| 7~24 (17s) | Though temperatures will rise to around 20 degrees |
| | Celsius during the day, the morning and evening |
| | temperatures may drop below 10 degrees. Because |
| | temperature varies much, it's good to dress accordingly. |
| | This is a particularly cold day of the season, and morning |
| | dew or frost is expected so be mindful when going out. |

FIG. 3B illustrates an example of a response 30 that includes: a first candidate chunk 31; a second candidate chunk 32 having a first candidate sub-chunk 320 with a first sentence element and a second candidate sub-chunk 322 with a second sentence element; and a third chunk 33. In FIG. 3B, the response 30 is segmented into multiple chunks 34 and 35 based on the second-level grammatical markers which are located between sentence elements playback times are assigned for the respective chunks 34 and 35.

The scheduler 260 may identify candidate boundaries between chunks based on delimiters contained in the text script. For example, the scheduler 260 may divide, based on delimiters, a second sentence contained in a target candidate chunk 32 that is scheduled to conflict with the driver assistance audio 39, resulting in a plurality of candidate sub-chunks 320 and 322 in sentence element units. Based on the durations D₁₂₁ and D₁₂₂ of the respective sentence elements, the scheduler 260 may estimate the playback time ranges [S₁₁+D₁₁, S₁₁+D₁₁+D₁₂₁] and [S₁₁+D₁₁+D₁₂₁, S₁₁+D₁₁+D₁₂] of the respective candidate sub-chunks 320 and 322.

Table 6 shows an example of subdividing the example candidate chunks in Table 4 based on delimiters.

TABLE 6

| Time Range | Candidate Chunk |
|---|---|
| 0~2 (2s) | It's chilly in Seoul today. |
| 2~5 (3s) | Though temperatures will rise to around 20 degrees |
| | Celsius during the day, |
| 5~8 (3s) | the morning and evening temperatures may drop below |
| | 10 degrees. |
| 8~9.5 (1.5s) | Because temperature varies much, |
| 9.5~12 (2.5s) | it's good to dress accordingly. |
| 12~15 (3s) | This is a particularly cold day of the season, |
| 15~19 (4s) | and morning dew or frost is expected so be mindful |
| | when going out. |

Table 6 shows an example of subdividing all candidate chunks within the response, but the present disclosure is not so limited. As described above, the scheduler 260 may further segment only those target candidate chunks 32 that have overlapping time ranges with the driver assistance audio 39.

The scheduler 260 may identify, from among the plurality of candidate sub-chunks 320 and 322, a target candidate sub-chunk that has an overlapping playback time range with the driver assistance audio 39. In the example of FIG. 3B, the second candidate sub-chunk may be determined as a target candidate sub-chunk.

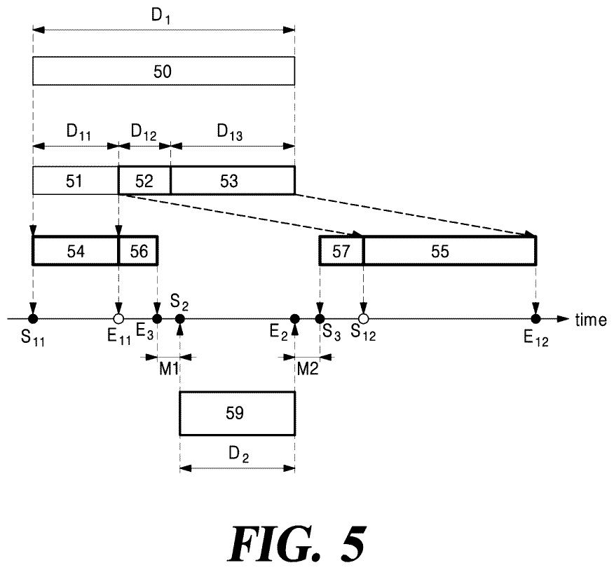

If there are multiple candidate sub-chunks with overlapping playback time ranges, the earliest candidate sub-chunk may be identified as the target candidate sub-chunk. The scheduler 260 may group the candidate chunk(s) 31 and/or candidate sub-chunk(s) 320 preceding the target candidate sub-chunk 322 into a single chunk 34, and may group the target candidate sub-chunk 322 and its following candidate chunk(s) 33 and/or candidate sub-chunk(s) (of which there are none in the example of FIG. 5B) into a single chunk 35, and may assign non-contiguous playback time ranges [S₁₁, E₁₁] and [S₁₂, E₁₂] to the two grouped chunks 34 and 35.

Table 7 shows an example of alternately outputting the speech response 30 and the driver assistance audio 39 in sentence element units when the playback start time point S₂ of the driver assistance audio 39 is later than the playback end time of the first candidate sub-chunk and earlier than the playback end time of the second candidate sub-chunk.

TABLE 7

| Time | Output Audio |
|---|---|
| 0~5 (5s) | It's chilly in Seoul today. Though temperatures will rise to |
| | around 20 degrees Celsius during the day, |
| 5~6 (1s) | (Margin) |
| 6~9 (3s) | [Take the right exit after 300 meters.] |
| 9~10 (1s) | (Margin) |
| 10~24 (14s) | the morning and evening temperatures may drop below 10 |
| | degrees. Because temperature varies much, it's good to dress |
| | accordingly. This is a particularly cold day of the season, |
| | and morning dew or frost is expected so be mindful |
| | when going out. |

To prevent the user from missing the context of the speech response 30, the scheduler 260 may prioritize the alternating output in sentence units over the alternating output in sentence element units. For example, the scheduler 260 may attempt to perform segmentation in sentence element units only when the time interval between the driver assistance audio 39 and the playback start time of the target candidate chunk 32 as divided into sentence units, i.e., the leading margin time M1, is greater than a predetermined maximum margin time. Additionally or alternatively, the scheduler 260 may determine the dividing point by comparing the first leading margin time estimated based on the target candidate chunk 32 with the second leading margin time estimated based on the target candidate sub-chunk 322.

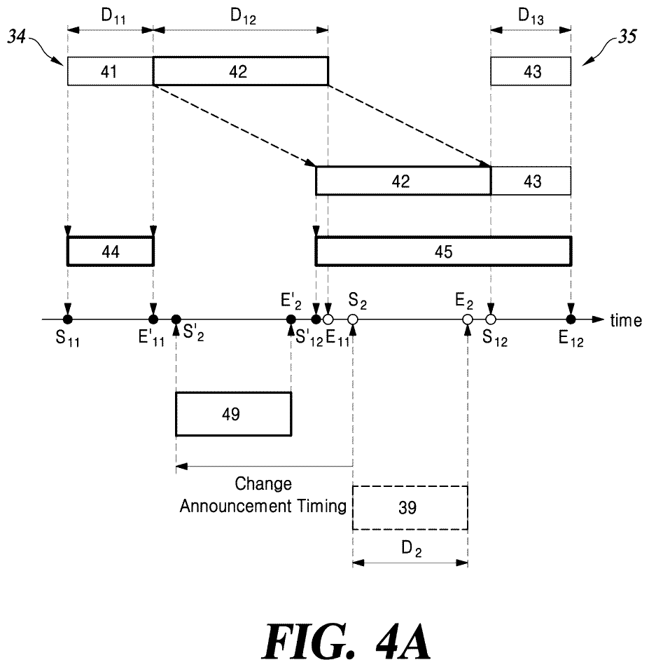

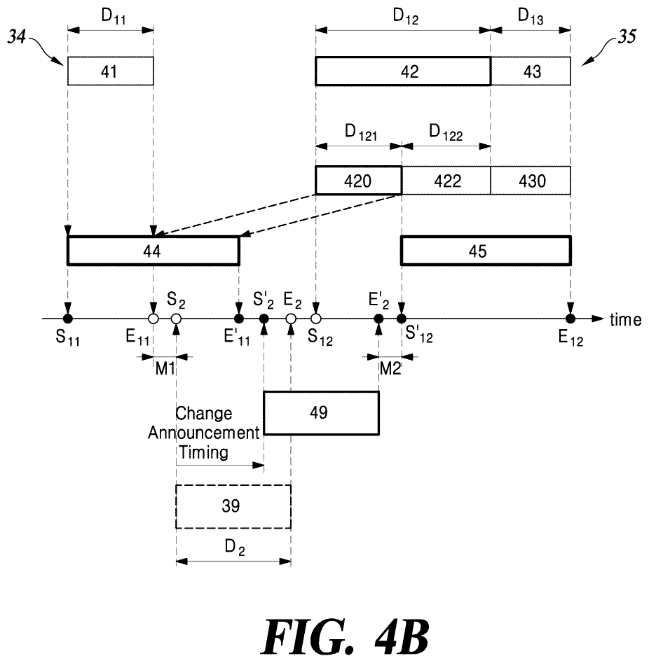

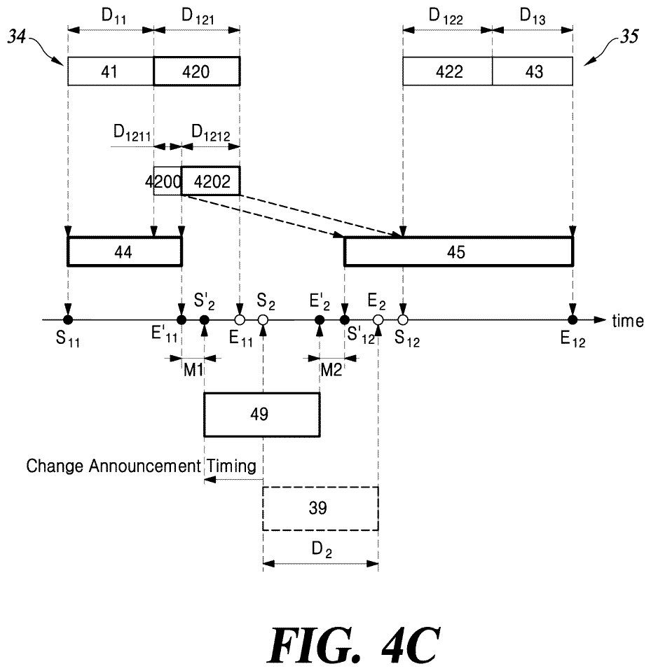

FIGS. 4A, 4B and 4C are diagrams illustrating the operation of rescheduling the playback time of the speech response, according to various exemplary embodiments of the present disclosure. In FIG. 4A, FIG. 4B and FIG. 4C, examples are shown of reconstructing new multiple chunks 44 and 45 by re-segmenting a response that was previously divided into multiple chunks 34 and 35, with each figure illustrating a re-segmentation based on a different level of grammatical markers.

The playback start time point S₂ of the driver assistance audio may be updated in real time based on the driving conditions of the vehicle. For example, when the vehicle speeds up, the playback start time point S₂ of the driver assistance audio may be advanced, and when the vehicle slows down, the playback start time point S₂ of the driver assistance audio may be delayed. The scheduler 260 may use as a basis the updated playback start time point S′₂ received periodically or aperiodically from the driver assistance system 140, for re-identifying boundaries between chunks and reassigning playback time. In the examples of FIG. 4A, FIG. 4B and FIG. 4C, the driver assistance audio with the updated playback start time point is renumbered as 49.

FIG. 4A illustrates an example of restructuring multiple chunks 44 and 45 based on the first-level grammatical markers which are located between sentences, and assigning playback times to the respective chunks 44 and 45. In the example of FIG. 4A, it is assumed that a previously configured preceding chunk 34 includes a first candidate chunk 41 containing a first sentence and a second candidate chunk 42 containing a second sentence. It is also assumed a previously configured following chunk 35 includes a third candidate chunk 43 containing a third sentence.

The scheduler 260 may compare the playback time ranges [S₁₁, E₁₁] and [S₁₂, E₁₂] of the pre-configured chunks 34 and 35 with the updated playback time range [S′₂, E′₂] of the driver assistance audio 49 to identify the chunk that is predicted to conflict. In the example of FIG. 4A, the preceding chunk 34 may be identified as the predicted conflicting chunk. The scheduler 260 may search within the identified chunk for the locations of the first-level grammatical markers to determine where to re-divide the response. For example, as in the example of FIG. 4A, if the updated playback start time point S′₂ of the driver assistance audio 49 precedes the playback end time point En of the already divided preceding chunk 34, the scheduler 260 may determine if a boundary between sentences exists within the preceding chunk 34 and/or if the preceding chunk 34 may be divided at that boundary to avoid the conflict.

Additionally or alternatively, the scheduler 260 may identify boundaries to re-divide the response based on the pre-estimated original playback time ranges [S₁₁, S₁₁+D₁₁], [S₁₁+D₁₁, S₁₁+D₁₁+D₁₂], and [S₁₁+D₁₁+D₁₂, S₁₁+D₁] for the candidate chunks 41, 42 and 43 divided into sentence units. Here, the original playback time ranges may represent the playback time ranges of the respective candidate chunks 41, 42 and 43, assuming the speech response is not divided. The scheduler 260 may compare the original playback time range with the updated playback time range [S′₂, E′₂] of the driver assistance audio 49 to identify boundaries to re-divide the response. For example, if the updated playback time range [S′₂, E′₂] of the driver assistance audio 49 overlaps with the original playback time range [S₁₁+D₁₁, S₁₁+D₁₁+D₁₂] of the second candidate chunk 42, the scheduler 260 may restructure the chunks 44 and 45 so that the second sentence contained in the second candidate chunk 42 is played after the driver assistance audio 49.

The scheduler 260 may assign non-contiguous playback times [S₁₁, E′1] and [S′12, E′12] to the restructured chunks 44 and 45.

Some examples may perform re-identification of the segmentation boundary by using the first-level grammatical markers only before starting the playback of the speech response. For example, if the current time point precedes the playback start time point S₁₁ of the speech response, candidate chunks 41, 42, and 43 of a sentence unit may be used to re-search the dividing point in the response. Additionally or alternatively, if a suitable dividing point is not searched at the boundary between the candidate chunks 41, 42, and 43 of the sentence unit and/or if the speech response is already playing, the search may be performed by using lower-level grammatical markers, which will be described below. Additionally or alternatively, the scheduler 260 may immediately perform the searching by using the lower-level grammatical markers if playback of the chunk 34, which is predicted to conflict with the driver assistance audio, has already begun.

FIG. 4B illustrates an example of restructuring multiple chunks based on the second-level grammatical markers which are located between sentences elements, and assigning playback times to the respective chunks. In the example of FIG. 4B, it is assumed that a previously configured preceding chunk 34 includes a first candidate chunk 41, and that a previously configured following chunk 35 includes a second candidate chunk 42 and a third candidate chunk 43. It is also assumed that the second candidate chunk 42 has a first candidate sub-chunk 420 with a first sentence element and a second candidate sub-chunk 422 with a second sentence element.

The scheduler 260 may compare the playback time ranges [S₁₁, E₁₁] and [S₁₂, E₁₂] of the pre-configured chunks 34 and 35 with the updated playback time range [S′₂, E′₂] of the driver assistance audio 49 to identify chunk that is predicted to conflict. In the example of FIG. 4B, the following chunk 35 may be identified as the predicted conflicting chunk. The scheduler 260 may search boundaries between sentence elements within the identified chunk to determine the points where to re-divide the response. For example, as in the example of FIG. 4B, if the updated playback end time point E′₂ of the driver assistance audio 49 is later than the playback start time point S₁₂ of the already divided following chunk 35, the scheduler 260 may determine if a boundary between sentence elements exists within the following chunk 35 and/or if the following chunk 35 may be divided at that boundary to avoid the conflict.

Additionally or alternatively, the scheduler 260 may identify a boundary to re-divide the response by comparing the original playback time ranges [S₁₁+D₁₁, S₁₁+D₁₁+D₁₂₁] and [S₁₁+D₁₁+D₁₂₁, S₁₁+D₁₁+D₁₂] of the candidate sub-chunks 420 and 422 divided in sentence element units with the updated playback time range [S′₂, E′₂] of the driver assistance audio 49. For example, if the updated playback time range [S′₂, E′₂] of the driver assistance audio 49 overlaps with the original playback time range [S₁₁+D₁₁+D₁₂₁, S₁₁+D₁₁+D₁₂] of the second candidate sub-chunk 422 containing the second sentence element, the scheduler 260 may restructure the chunks 44 and 45 so that all of the sentence (e.g. the first sentence contained in first candidate chunk 41) and the sentence elements (e.g., the first sentence element contained in first candidate sub-chunk 420) before that second sentence element are played ahead of the driver assistance audio.

FIG. 4C illustrates an example of restructuring multiple chunks based on the third-level grammatical markers which are located within a sentence or a sentence element, and assigning playback times to the respective chunks. In the example of FIG. 4C, it is assumed that a previously configured preceding chunk 34 includes a first candidate chunk 41 and a first candidate coarse sub-chunk 420, and that a previously configured following chunk 35 includes a second candidate coarse sub-chunk 422 and a third candidate chunk 43. It is also assumed that the first candidate coarse sub-chunk 420 has a first candidate fine sub-chunk 4200 containing first sub-sentence element and a second candidate fine sub-chunk 4202 containing second sub-sentence element.

The scheduler 260 may also identify boundaries to re-divide the response based on connective endings or connectives contained in the text script. For example, the scheduler 260 may subsidiarily utilize grammatical markers in the third level if no suitable dividing point is searched among locations corresponding to grammatical markers in the first and second levels. Additionally or alternatively, the scheduler 260 may also utilize the third-level grammatical markers to further subdivide the response into more specific (or finer-grained) semantic units and/or more specific (or finer-grained) syntactic units if a chunk that is predicted to conflict with the driver assistance audio is already playing.

The scheduler 260 may compare playback time ranges [S₁₁, E₁₁] and [S₁₂, E₁₂] of the pre-configured chunks 34 and 35 with the updated playback time range [S′₂, E′₂] of the driver assistance audio 49 to identify chunk that is predicted to conflict. In the example of FIG. 4B, the preceding chunk 34 may be identified as the chunk that is predicted to conflict. The scheduler 260 may search locations within the identified chunk 34, corresponding to connective endings or connectives, to determine where to re-divide the response. Here, the connective ending is a grammatical morpheme that is attached to verb stems or word stems in Korean grammar and functions to link phrases or clauses. For example, connective endings may include ‘ [symbol] (-ge)’, ‘ [symbol] (-go)’, ‘ [symbol] (-eumyeo/myeo)’, ‘ [symbol] (-eumyeon/myeon)’, ‘ [symbol] (-euni/ni)’, ‘ [symbol] (-ah/uh)’, ‘- [symbol] (-ji)’, etc. Connectives may refer to a word class or words or phrases that function to grammatically link two or more phrases, clauses, or sentences. Connectives may include conjunctions or relative pronouns. For example, connectives may include ‘and’, ‘but’, ‘or’, ‘because’, ‘although’, ‘which’, ‘that’, and the like. For example, as in the example of FIG. 4C, if the updated playback start time point S′₂ of the driver assistance audio 49 is earlier than the playback end time point En of the already divided preceding chunk 34, the scheduler 260 may determine if a connective ending or connective is present within the preceding chunk 34 and/or if a division of the preceding chunk 34 may be made at that position to avoid the conflict.

Additionally or alternatively, the scheduler 260 may divide the candidate chunk(s) 41 and/or 43 or candidate coarse sub-chunk(s) 420 and/or 422 based on the connective endings or connectives to form a plurality of candidate fine sub-chunks 4200 and 4202 in the units of sub-sentence elements. Based on the durations D₁₂₁₁ and D₁₂₁₂ of the respective sub-sentence elements contained in the candidate fine sub-chunks 4200 and 4202, the scheduler 260 may estimate the original playback time ranges [S₁₁+D₁₁, S₁₁+D₁₁+D₁₂₁₁] and [S₁₁+D₁₁+D₁₂₁₁, S₁₁+D₁₁+D₁₂₁] for the candidate fine sub-chunks 4200 and 4202.

Table 8 shows an example of subdividing the example candidate chunks in Table 6 based on connectives.

TABLE 8

| Time | Candidate Chunk |
|---|---|
| 0~2 (2s) | It's chilly in Seoul today. |
| 2~5 (3s) | Though temperatures will rise to around 20 degrees |
| | Celsius during the day, |
| 5~8 (3s) | the morning and evening temperatures may drop |
| | below 10 degrees. |
| 8~9.5 (1.5s) | Because temperature varies much, |
| 9.5~12 (2.5s) | it's good to dress accordingly. |
| 12~15 (3s) | This is a particularly cold day of the season, |
| 15~17 (2s) | and morning dew or frost is expected so |
| 17~19 (2s) | be mindful when going out. |

The scheduler 260 may compare the original playback time range of the candidate fine sub-chunks 4200 and 4202 with the updated playback time range [S′₂, E′₂] of the driver assistance audio 49 to identify a boundary to re-divide the response. For example, if the updated playback time range [S′₂, E′₂] of the driver assistance audio 49 overlaps with the original playback time range [S₁₁+D₁₁+D₁₂₁₁, S₁₁+D₁₁+D₁₂₁] of the second candidate fine sub-chunk 4202 containing the second sub-sentence element, the scheduler 260 may restructure the chunks 44 and 45 such that the second sub-sentence element is played after the driver assistance audio 49. The scheduler 260 may assign non-contiguous playback time ranges [S₁₁, E′11] and [S′12, E′12] to the restructured chunks 44 and 45.

Table 9 illustrates an example of alternately outputting the speech response segmented based on connectives.

TABLE 9

| Time | Output Audio |
|---|---|
| 0~17( 17s) | It's chilly in Seoul today. Though temperatures will rise to |
| | around 20 degrees Celsius during the day, the morning and |
| | evening temperatures may drop below 10 degrees. Because |
| | temperature varies much, it's good to dress accordingly. |
| | This is a particularly cold day of the season, and morning |
| | dew or frost is expected so |
| 17~18 (1s) | (Margin) |
| 18~21 (3s) | [Take the right exit after 300 meters.] |
| 21~22 (1s) | (Margin) |
| 22~24 (2s) | be mindful when going out. |

FIG. 5 is a diagram illustrating the operation of generating a speech response including a bridge voice, according to at least an exemplary embodiment of the present disclosure. In example of FIG. 5, it is assumed that a response 50, which includes a first candidate chunk 51, a second candidate chunk 52, and a third candidate chunk 53, is segmented into multiple chunks 54 and 55.

To provide a natural transition between audios from different domains, the scheduler 260 may insert a bridge audio 56 and 57 between each of the chunks 54 and 55 and the driver assistance audio 59. The bridge audio 56 and 57 may include a voice message informing the user that the remaining speech response will be played after the driver assistance audio 59. To this end, the scheduler 260 may receive from the natural language processing engine 220, but is not limited to, a speech response and/or a voice message that fits the context of the driver assistance audio 59. Additionally or alternatively, a prerecorded notification sound may be used as bridge audio 56 and 57.

The scheduler 260 may further take into account the duration of the bridge audio 56 and 57 in dividing the response 50 into multiple chunks 54 and 55. For example, in the example of FIG. 5, if the time interval between the playback end time point En of the preceding chunk 54 and the playback start time point S₂ of the driver assistance audio 59 is shorter than the sum of the duration of the bridge audio 56 and a predetermined threshold margin time, the scheduler 260 may further subdivide the sentence(s) and/or sentence element(s) contained in the preceding chunk 54 to form suitable preceding chunk.

Table 10 shows an example of outputting a speech response including bridge audios alternately with a driver assistance audio. For ease of identification, the bridge audio portions are separated from the driver assistance audio by using angle brackets.

TABLE 10

| | |
|---|---|
| Original | Hyundai Motor Group was founded in 1967, and is a South Korea's |
| Response | leading automobile manufacturer. In 1976, Hyundai launched its first in- |
| | house developed model the Pony and achieved a fair success in the |
| | domestic and international markets. Hyundai since then has expanded its |
| | presence in the global market through continuous technological |
| | development and quality improvement. Hyundai today is at the forefront |
| | of developing eco-friendly vehicles such as electric and hydrogen vehicles |
| | too, and its various models are loved by consumers around the world. |
| Output | Hyundai Motor Group was founded in 1967, and is a South Korea's |
| Audio | leading automobile manufacturer. <Answerer will continue after the GPS |
| | guidance.> [Turn right in 500 meters ahead.] <I will resume answers |
| | about the Hyundai Motor Group's history.> In 1976, Hyundai launched its |
| | first in-house developed model the Pony and achieved a fair success in the |
| | domestic and international markets. Hyundai since then has expanded its |
| | presence in the global market through continuous technological |
| | development and quality improvement. Hyundai today is at the forefront |
| | of developing eco-friendly vehicles such as electric and hydrogen vehicles |
| | too, and its various models are loved by consumers around the world. |

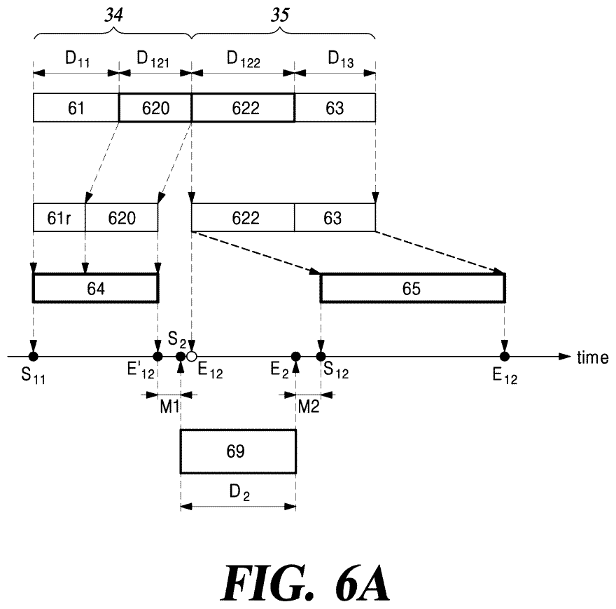

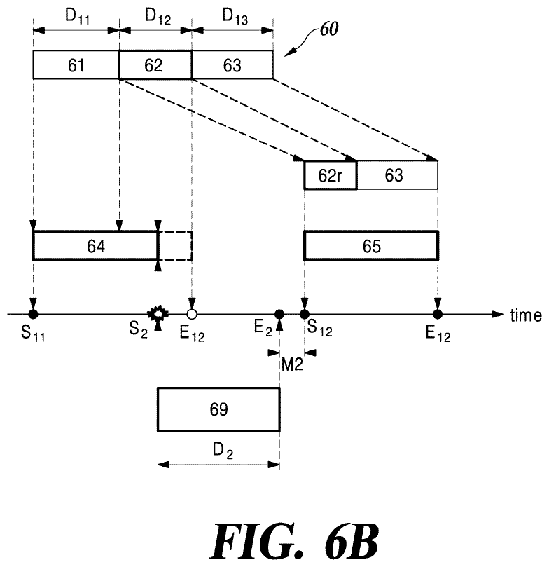

FIG. 6A and FIG. 6B are diagrams illustrating the operation of restructuring the content of the speech response, according to various exemplary embodiments of the present disclosure.

FIG. 6A illustrates an example of restructuring the content of a chunk that is played before an audio from another domain. In the example of FIG. 6A, it is assumed that a response with original content is segmented into a preceding chunk 34 and a following chunk 35. It is also assumed that the preceding chunk 34 contains a first sentence 61 and a first sentence element 620 of a second sentence, and the following chunk 35 contains a second sentence element 622 of a second sentence and a third sentence 63.

The scheduler 260 may restructure the content of the response to divide the same into semantic units or syntactic units to align with the playback start time point S₂ of the driver assistance audio 69.

The scheduler 260 may use as a basis the vehicle speed-dependent, real-time variable playback start time point S₂ of the driver assistance audio 69, for dynamically restructuring the content of the first half of the text script such that grammatical markers are positioned before the playback start time point S₂. For example, as in the example of FIG. 6A, if a playback end time point E₁₂ of the preceding chunk 34 configured according to the content of the original text script is later than the playback start time point S₂ of the driver assistance audio 69, the scheduler 260 may rephrase the text script to shorten the duration of the reconstructed sentence(s) 61r and/or the duration of the reconstructed sentence element(s) (of which there are none in the example of FIG. 6A) included in the reconstructed preceding chunk 64. Additionally or alternatively, to increase the number of candidate boundaries available for use in dividing the response, the scheduler 260 may rephrase the text script to include more grammatical markers. For example, in the example of FIG. 6A, the scheduler 260 may reconfigure or restructure the content of the sentence(s) 61 and/or the sentence element(s) 620 included in the preceding chunk 34 to segment the chunks 64 and 65 at the boundaries or inner points of the restructured sentence(s) 61r or restructured sentence element(s) (of which there are none in the example of FIG. 6A). The scheduler 260 may rephrase the text script by utilizing the natural language processing engine 220, to which the present disclosure is not limited.

Table 11 shows an example of rephrasing the response, taking into account the playback start time point of the driver assistance audio.

TABLE 11

| | |
|---|---|
| Original | Hyundai Motor Group was founded in 1967, and is a South Korea's leading |
| Response | automobile manufacturer. In 1976, Hyundai launched its first in-house |
| | developed model the Pony and achieved a fair success in the domestic and |
| | international markets. Hyundai since then has expanded its presence in the |
| | global market through continuous technological development and quality |
| | improvement. Hyundai today is at the forefront of developing eco-friendly |
| | vehicles such as electric and hydrogen vehicles too, and its various models |
| | are loved by consumers around the world. |
| Output | Hyundai Motor Group founded in 1967 is the leading Korean automobile |
| Audio | manufacturer. In 1976, Hyundai launched its in-house developed model one |
| | the Pony and achieved a fair success in the domestic and international |
| | markets. [Fixed speed camera 100 meters ahead.] Hyundai since the has |
| | expanded its presence in the global market through continuous |
| | technological development and quality improvement. Hyundai today is at |
| | the forefront of developing eco-friendly vehicles such as electric and |
| | hydrogen vehicles too, and its various models are loved by consumers |
| | around the world. |

FIG. 6B illustrates an example of restructuring the content of a chunk that is played after the audio from the other domain. In the example of FIG. 6B, it is assumed that a speech response 60 with original content contains a first sentence 61, a second sentence 62, and a third sentence 63. It is also assumed that the playback of an audio 69 from another domain begins during the playback of a second sentence 62. In this example, a preceding chunk 64 includes the part of a speech response 60 that has already been played before the playback of the audio 69 from the other domain begins, and a following chunk includes the part of the speech response 60 that is played after the playback of the audio 69 from the other domain ends.

Some examples may not predict the playback start time of the audio 69 from the other domain, but may immediately start the playback of the audio 69 from the other domain in response to a certain event occurrence. For example, driver assistance audio may include warning sounds, such as collision warning sounds or reverse warning sounds, which need to be outputted as soon as the relevant event occurs to alert the driver to the driving situation.

If such unpredictable audio 69 in terms of the playback start time has a higher priority than the speech response 60, it may force the speech response 60 to be interrupted at unintended positions. In example of FIG. 6B, the playback of the second sentence 62 is interrupted and cut off. The scheduler 260 may restructure the content of the chunk 65 that follows the audio 69 from the other domain to prevent the user from losing the context of the speech response 60 due to the forced interruption of playback of the speech response 60. For example, the scheduler 260 may restructure the content of the following chunk 65 such that the following chunk includes a summary 62r of the interrupted sentence 62 or sentence element due to the audio 69 from the other domain. The scheduler 260 may restructure the content of the following chunk 65 by using the natural language processing engine 220 during the time that the audio 69 from the other domain is played, to which the present disclosure is not limited.

Table 12 shows an example of restructuring the content of the response to allow replaying of a summary of content that is unintentionally interrupted due to the playback of the driver assistance audio.

TABLE 12

| | |
|---|---|
| Original | Hyundai Motor Group was founded in 1967, and is a South Korea's leading |
| Response | automobile manufacturer. In 1976, Hyundai launched its first in-house |
| | developed model the Pony and achieved a fair success in the domestic and |
| | international markets. Hyundai since then has expanded its presence in the |
| | global market through continuous technological development and quality |
| | improvement. Hyundai today is at the forefront of developing eco-friendly |
| | vehicles such as electric and hydrogen vehicles too, and its various models |
| | are loved by consumers around the world. |
| Output Audio | Hyundai Motor Group was founded in 1967, and is a South Korea's leading |
| | automobile manufacturer. In 1976, Hyundai launched its first in-house |
| | developed model the Pony and [event warning sound] the first model of |
| | Pony achieved a fair success in the domestic and international markets. |
| | Hyundai since then has expanded its presence in the global market through |
| | continuous technological development and quality improvement. Hyundai |
| | today is at the forefront of developing eco-friendly vehicles such as electric |
| | and hydrogen vehicles too, and its various models are loved by consumers |
| | around the world. |

While the above describes an example of a speech response and a single driver assistance audio being alternately outputted, multiple driver assistance audios may be outputted alternately with the speech response, depending on the driving situation of the vehicle 10.

Table 13 shows an example of outputting the speech response alternately with two driver assistance audios.

TABLE 13

| | |
|---|---|
| Original | Hyundai Motor Group was founded in 1967, and is a South Korea's leading |
| Response | automobile manufacturer. In 1976, Hyundai launched its first in-house |
| | developed model the Pony and achieved a fair success in the domestic and |
| | international markets. Hyundai since then has expanded its presence in the |
| | global market through continuous technological development and quality |
| | improvement. Hyundai today is at the forefront of developing eco-friendly |
| | vehicles such as electric and hydrogen vehicles too, and its various models |
| | are loved by consumers around the world. |
| Output Audio | Hyundai Motor Group was founded in 1967, and is a South Korea's leading |
| | automobile manufacturer. [Turn right in 500 meters ahead.] In 1976, |
| | Hyundai launched its first in-house developed model the Pony and achieved |
| | a fair success in the domestic and international markets. Hyundai since then |
| | has expanded its presence in the global market through continuous |
| | technological development and quality improvement. Hyundai today is at |
| | the forefront of developing eco-friendly vehicles such as electric and |
| | hydrogen vehicles too, [Turn right in 100 meters ahead.] and its various |
| | models are loved by consumers around the world. |

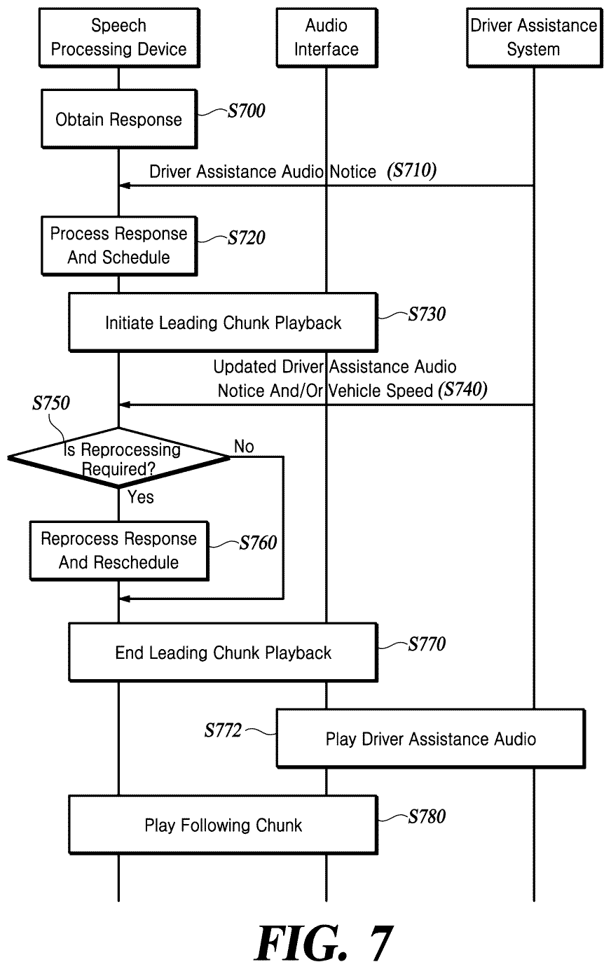

FIG. 7 is a flowchart of a method for speech response processing triggered by a driver assistance audio notice, according to at least an exemplary embodiment of the present disclosure.

The speech processing device 120 may obtain a response to provide to the user (S700). For example, the response may be an answer to the user's question.

The speech processing device 120 may receive a driver assistance audio notice from the driver assistance system 140 (S710). The driver assistance audio notice may be information announcing that driver assistance audio is about to be outputted. For example, the driver assistance audio notice may include a time interval from the current time to when the driver assistance audio notice will start to play. Additionally or alternatively, the driver assistance audio notice may include an absolute time at which playback of the driver assistance audio notice is to start. Additionally or alternatively, the driver assistance audio notice may include the duration of the driver assistance audio. Additionally or alternatively, the driver assistance audio notice may include text to be announced via the driver assistance audio or the number of its characters.

The speech processing device 120 may process the response into multiple chunks such that the response is readable in chunks to coincide with the playback start time of the driver assistance audio, and schedule a playback time for each chunk (S720). The multiple chunks may include a preceding chunk to be outputted before the driver assistance audio, and a following chunk to be outputted after the driver assistance audio. For example, the speech processing device 120 may perform response processing and scheduling based on the methods described above in FIGS. 3A, 3B, FIG. 5, and FIG. 6A or 6B.

The speech processing device 120 may initiate playback of the preceding chunk based on the playback time allocated to the preceding chunk (S730). The speech processing device 120 may output a speech signal corresponding to the preceding chunk to the audio interface 100.

The speech processing device 120 may receive an updated driver assistance audio notice and/or vehicle speed from the driver assistance system 140 (S740). For example, the driver assistance system 140 may determine whether the playback start time of the driver assistance audio and/or vehicle speed has changed by a predetermined percentage or more, and if so, transmit the updated driver assistance audio notice and/or vehicle speed to the speech processing device 120. Additionally or alternatively, the driver assistance system 140 may transmit updated driver assistance audio notices and/or vehicle speeds at preset time intervals to the speech processing device 120.

The speech processing device 120 may determine, based on the updated driver assistance audio notice and/or vehicle speed, whether the response requires reprocessing (S750). For example, the speech processing device 120 may determine that reprocessing of the response is needed when the updated playback time range of the driver assistance audio overlaps with the playback time range of a divided chunk. Additionally or alternatively, the speech processing device 120 may determine that reprocessing of the response is needed when the vehicle speed has changed by a predetermined percentage or more. Additionally or alternatively, the speech processing device 120 may determine that reprocessing of the response is needed when the vehicle 10 is stopped by a traffic signal or stop sign.

The speech processing device 120 may reprocess the response into multiple chunks such that the response is readable in chunks to coincide with an updated playback start time of the driver assistance audio, and reschedule the playback time for each chunk (S760). For example, if the playback start time of the driver assistance audio is advanced, the speech processing device 120 may separate the contents of the preceding chunk into semantic units or syntactic units to reduce the duration of the preceding chunk. If the playback start time of the driver assistance audio is delayed, the speech processing device 120 may separate the contents of the following chunk into semantic or syntactic units and move them to the preceding chunk. The speech processing device 120 may perform response reprocessing and rescheduling based on the methods described above in FIG. 4A, 4B, 4C, 5, 6A, or 6B.

The speech processing device 120 may terminate playback of the preceding chunk based on the playback time allocated thereto (S770). If the preceding chunk and the following chunk are classified as separate audio files, playback of the preceding chunk may be automatically terminated upon completion of playback of the audio file corresponding to the preceding chunk. Additionally or alternatively, if the preceding chunk and the following chunk are separated by a timestamp within a single audio file, the speech processing device 120 may stop playback of the preceding chunk based on that timestamp.

The driver assistance system 140 may play the driver assistance audio at a time determined based on the driving situation of the vehicle (S772). For example, the driver assistance system 140 may output voice prompts on the route at an appropriate time based on the vehicle's current location, speed, direction of travel, etc.

The speech processing device 120 may play the following chunk based on the playback time allotted to the following chunk (S780). For example, the speech processing device 120 may output a speech signal corresponding to the following chunk to the audio interface 100 after a predetermined margin time has elapsed from when the playback of the driver assistance audio has ended (or after it was assumed to end).

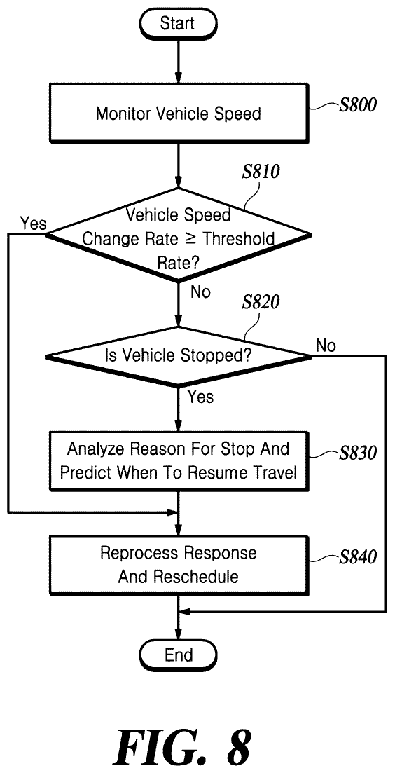

FIG. 8 is a flowchart of a response reprocessing process according to at least an exemplary embodiment of the present disclosure.

The speech processing device 120 may periodically or aperiodically monitor the speed of the vehicle 10 (S800). For example, the speech processing device 120 may periodically or aperiodically receive speed data of the vehicle 10 from the driver assistance system 140. Additionally or alternatively, the speech processing device 120 may read the speed data of the vehicle 10 directly from a speed sensor mounted on the vehicle 10.

The speech processing device 120 may determine whether the speed change rate of the speed of the vehicle 10 is greater than or equal to a preset threshold rate (S810). The speed change rate may be, for example, a rate of change between the vehicle speed at the current time and the vehicle speed at a time when the speech response was divided into multiple chunks. The threshold rate may be set to, but not limited to, 10%, for example. The threshold rate may be set differently depending on the duration of the predetermined margin time inserted between the speech response and the driver assistance audio.

If the speed change rate of the vehicle 10 is greater than or equal to the preset threshold rate, the speech processing device 120 may use as a basis the newly predicted playback start time of the driver assistance audio according to the change in speed, for reprocessing the response and then schedule a time to play each chunk of the response (S840). The speech processing device 120 may reprocess the response in different ways depending on whether or not the speech response is being played at the current time. For example, if the speech response playback has not yet started, the speech processing device 120 may re-search the dividing points of the speech response in a stepwise manner, first in sentence units, next in sentence element units, and then in sub-sentence element units. The speech processing device 120 may prioritize the segmentation in sentence units. If the speech response is already playing, the speech processing device 120 may search for the dividing point of the speech response first in units of sentence elements or sub-sentence elements.

If the speed change rate of the speed of the vehicle 10 is less than the preset threshold rate, the speech processing device 120 may determine whether the vehicle 10 is currently stopped (S820). For example, the speech processing device 120 may determine whether the vehicle 10 is currently stopped based on whether the current speed of the vehicle 10 is 0 km/h.

If the vehicle 10 is currently stopped, the speech processing device 120 may analyze the reason for the vehicle 10's stop and predict when the vehicle 10 may resume travel (S830). For example, if the vehicle 10 is stopped due to a traffic signal or stop sign, the speech processing device 120 may receive the remaining time of the traffic signal or the stop signal from the ITS server and predict when to resume travel based on the remaining time. To analyze the reason for the vehicle 10's stop, the speech processing device 120 may utilize information received from the ITS server and/or the current location of the vehicle 10. Additionally or alternatively, the speech processing device 120 may also analyze whether the vehicle 10 is stopped due to an accident based on information obtained from the driver assistance system 140, information received from the ITS server, and/or the current location of the vehicle 10, and accordingly predict when the vehicle 10 will resume the travel.

The speech processing device 120 may use as a basis the newly predicted playback start time of the driver assistance audio according to the time when the travel will resume, for reprocessing the response, and then it may schedule a time to play each chunk (S840). The speech processing device 120 may search the dividing points of the speech response first in units of sentence elements or sub-sentence elements, to which the present disclosure is not limited.

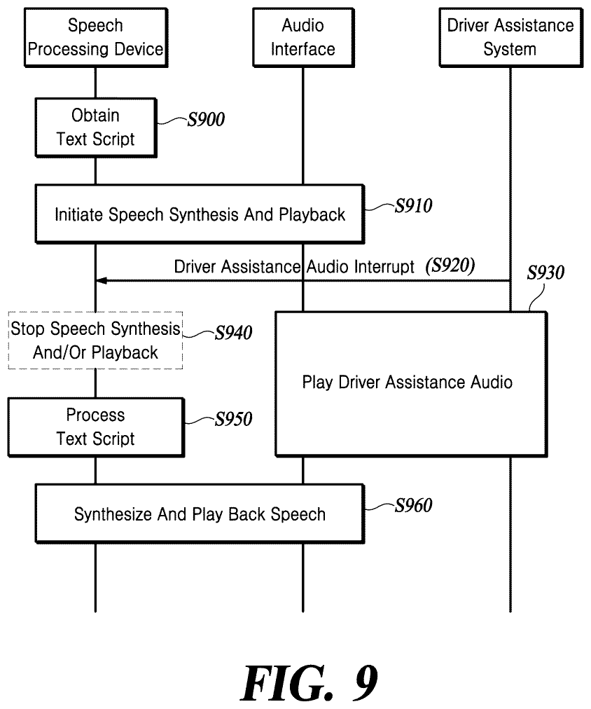

FIG. 9 is a flowchart of a method for speech response processing triggered by a driver assistance audio interrupt, according to at least an exemplary embodiment of the present disclosure.

The speech processing device 120 may obtain a text script to be synthesized into speech (S900). For example, the text script may include an answer to a user's question.

The speech processing device 120 may synthesize speech based on the text script, and may initiate playback of the synthesized speech (S910). For example, the speech processing device 120 may output a real-time synthesized audio stream from the speech synthesis engine 240 by using the audio interface 100.

The speech processing device 120 may receive a driver assistance audio interrupt from the driver assistance system 140 (S920). The driver assistance audio interrupt may be information announcing that driver assistance audio is to be outputted immediately. For example, in response to a collision or reverse driving event, the driver assistance system 140 may output a warning sound and send, at the same time, a driver assistance audio interrupt to the speech processing device 120. Additionally or alternatively, the speech processing device 120 may monitor the audio interface 100 or the driver assistance system 140 to determine whether an output of speech response is being blocked by another domain.

As the driver assistance system 140 plays the driver assistance audio (S930), the speech processing device 120 may stop both the speech synthesis and playback (S940).

The speech processing device 120 may process the content of the text script portion that follows the paused position to include a summary of the text script portion that precedes the paused position (S950).

At the end of playback of the driver assistance audio, the speech processing device 120 may synthesize the processed text script into speech and/or play the synthesized speech (S960). In some examples, the speech processing device 120 may pre-synthesize all or a portion of the processed text while the driver assistance audio is played.

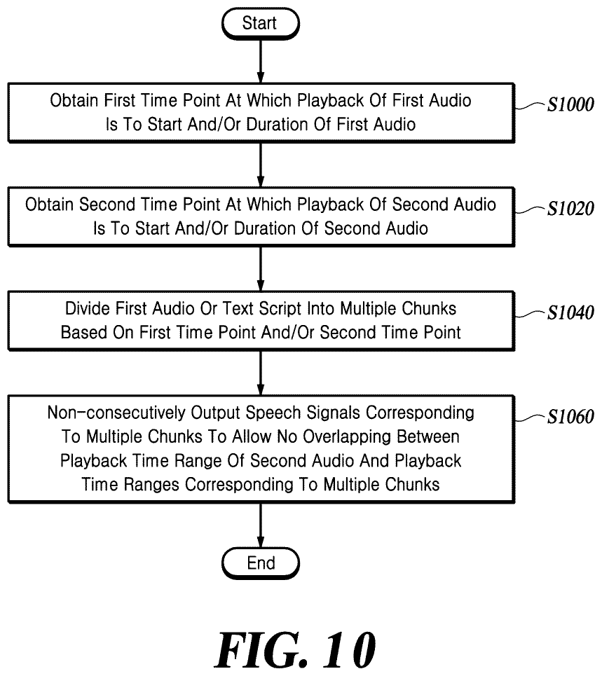

FIG. 10 is a flowchart of a method of dynamically outputting audios, according to at least an exemplary embodiment of the present disclosure.

The speech processing device 120 obtains a first time point at which playback of a first audio is to start and/or a duration of the first audio (S1000). The first audio may include speech signals that are or will be synthesized based on a text script. In some examples, the first audio may be outputted to the interior of the vehicle. The text script may include text obtained based on the user's request. For example, the text script may be text generated by a language model in response to a user's query. The speech processing device 120 may generate the text script by using an on-device artificial intelligence model, or may request the server 14 to generate the text script. Additionally or alternatively, the text script may be a pre-stored text for which the user has requested speech synthesis. The first time point may be, for example, a time point of generating or receiving the text script, plus a delay of a predetermined buffering time. The buffering time may include, for example, a pre-loading time required to pre-synthesize a portion of the text script. In some examples, the first audio may already be playing. The speech processing device 120 may extract a first time point when playback of the first audio began. The speech processing device 120 may estimate a duration of the first audio based on the length of the text script. The length of the text script may represent the number of characters. The duration of the first audio may represent the time it takes to speak the text script. Based on the number of characters of the individual words constituting the text script, the speech processing device 120 may also predict the durations of the speech signals corresponding to those words. For this purpose, an average speaking rate of the synthesized voice may be preset. Additionally or alternatively, the speech processing device 120 may utilize a speech synthesis engine to estimate the durations of individual phonemes in the first audio, which may be summed to obtain a per-word duration and/or obtain the duration from the first audio. Additionally or alternatively, the speech processing device 120 may synthesize the first audio by using the text script and extract, from the synthesized first audio, the per-word duration and/or the overall duration of the first audio.

The speech processing device 120 may obtain a second time point at which playback of the second audio is predicted to start and/or a duration of the second audio (S1020). The second audio may have a higher priority than the first audio. The second audio may be outputted to the interior of the vehicle. For example, the second audio may include voice prompts to assist in driving the vehicle. The speech processing device 120 may periodically or aperiodically receive the second time point from the driver assistance system 140. The speech processing device 120 may receive an absolute time corresponding to the second time point, or may receive a time interval between the current time point and the second time point. The speech processing device 120 may further receive the duration of the second audio from the driver assistance system 140. Additionally or alternatively, the speech processing device 120 may receive guidance text corresponding to the second audio from the driver assistance system 140 and use the guidance text to estimate the duration of the second audio.

The speech processing device 120 may divide the text script or the first audio into multiple chunks based on the first time point, the second time point, the duration of the first audio, and/or the duration of the second audio (S1040). The speech processing device 120 may determine a boundary between the multiple chunks based on grammatical markers that separate one or more semantic elements of the text script, i.e. semantic units, or one or more syntactic elements of the text script, i.e. syntactic units. Here, the grammatical markers may include punctuation, connective endings, or connectives. For example, the text script may include one or more first-level grammatical markers indicating boundaries between different sentences and/or one or more second-level grammatical markers indicating boundaries between different sentence elements within a single sentence. The speech processing device 120 may perform a hierarchical search over the first-level grammatical markers and the second-level grammatical markers to determine a dividing point for the text script or first audio. The hierarchical search may represent searching over a higher level (e.g., the first level) first, and only if a suitable dividing point has not been searched in that higher level, secondly searching over a lower level (e.g., the second level).

In some examples, the speech processing device 120 may divide the text script into a plurality of first candidate text chunks, each containing a sentence or clause. For example, the speech processing device 120 may identify boundaries between sentences or clauses based on punctuation, such as periods or commas. The speech processing device 120 may determine a target text chunk corresponding to the second time point from among the plurality of first candidate text chunks. The speech processing device 120 may divide the identified target text chunk into a plurality of second candidate text chunks, each containing a clause or phrase. For example, the speech processing device 120 may identify boundaries between clauses or phrases based on punctuation, such as commas, or linking markers, such as connective endings or connectives. The speech processing device 120 may generate, based on the second time point, a plurality of text chunks by grouping the plurality of first candidate text chunks excluding the target text chunk and the plurality of second candidate text chunks. In some examples, the speech processing device 120 may restructure the sentence structure of the text script such that grammatical markers are placed within the reconstructed text script at a location corresponding to the second time point. For example, the speech processing device 120 may restructure the text script by using a language model, to which the present disclosure is not limited.

The speech processing device 120 may non-consecutively output speech signals corresponding to the multiple chunks, such that the first playback time ranges corresponding to the multiple chunks do not overlap with the second playback time range of the second audio (S1060). The multiple chunks may include a first chunk that is played before the second audio, and a second chunk that is played after the second audio. Based on the first time point, the second time point, and/or the duration of the second audio, the speech processing device 120 may determine a third time point at which a playback of the second chunk is to start. The third time point may be, for example, a fourth time point at which the playback of the second audio is predicted to end, plus a delay of a predetermined margin time. The speech processing device 120 may dynamically set the predetermined margin time based on the current speed of the vehicle. Additionally or alternatively, the speech processing device 120 may dynamically set the predetermined margin time based on whether the vehicle is stopped and/or a fifth time point at which the vehicle is predicted to resume traveling.

In some examples, the speech processing device 120 may determine whether the text script or first audio is needs to be re-divided based on a change in a speed of the vehicle. The speech processing device 120 may determine that re-division is necessary if the speed change rate of the vehicle is greater than a predetermined threshold. The speech processing device 120 may adaptively re-divide the text script or first audio based on an updated second time point that is updated in real time as the vehicle is traveling. The speech processing device 120 may determine which of the first level grammatical markers and the second level grammatical markers to begin searching with, based on whether playback of at least some of the multiple chunks has already begun. In some examples, the text script may further include one or more third-level grammatical markers that link different syntactic units within a single sentence element. The speech processing device 120 may hierarchically search through the second-level grammatical markers and the third-level grammatical markers to determine a re-dividing point for the text script or first audio. For example, based on the updated second time point, the speech processing device 120 may determine, from among the divided chunks, a target chunk having a playback time range that overlaps with the second audio. The speech processing device 120 may hierarchically search through the second-level grammatical markers and the third-level grammatical markers within the determined target chunk to determine a re-dividing point for the text script or first audio.

In some examples, the speech processing device 120 may output one or more bridge audios for announcing that a second chunk is to be played after the second audio, at a time distinct from the second playback time range of the second audio. For example, the first bridge audio may be played consecutively to the first chunk, followed by a predetermined margin time before the second audio is played. At the end of the playback of the second audio, another predetermined margin time may be present before playing the second bridge audio, to which the second chunk may be played consecutively.

In some examples, the speech processing device 120 may restructure the text script based on the occurrence of a third audio that needs to be played immediately. For example, the restructured text script may include a summary of the content portion that has recently been played in the first audio and the content portion that has not yet been played. Upon the occurrence of the third audio, playback of the first audio may stop. The recently played content of the first audio may include one or more semantic units or one or more syntactic units that were played immediately before the first audio was stopped. In response to the termination of playback of the third audio, the speech processing device 120 may output a speech signal corresponding to the restructured text script.

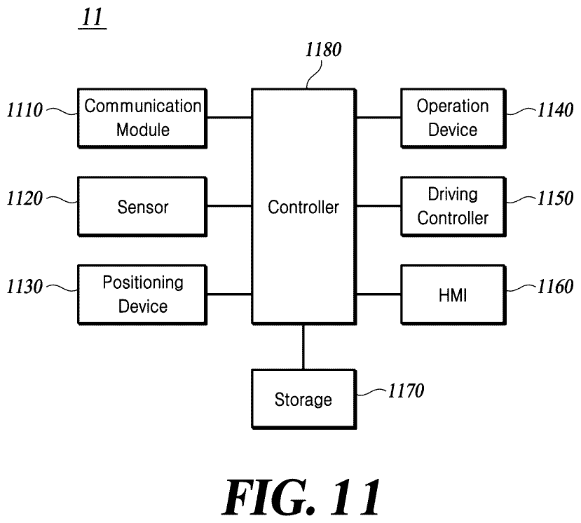

FIG. 11 is a block diagram schematically illustrating an example vehicle that can be used to implement the method or apparatus according to embodiments of the present disclosure.

The vehicle 11 may include at least one of a communication module 1110, a sensor 1120, a positioning device 1130, an operation device 1140, a driving controller 1150, a human machine interface unit (HMI) 1160, a storage 1170, and a controller 1180.

The communication module 1110 may exchange signals with devices positioned outside and inside the vehicle 11. The communication module 1110 may exchange a signal with at least one of an infrastructure device, such as a server or a base station, another vehicle, and a terminal. The communication module 1110 may include at least one of a transmission antenna, a reception antenna, a radio frequency (RF) circuit capable of implementing various communication protocols, and an RF element to perform communication. The communication module 1110 may include an internal communication part and an external communication part. The internal communication part may transmit or receive signals by using various communication protocols present in the vehicle 11. In this regard, an internal communication protocol may include at least one of a controller area network (CAN), a CAN with flexible data rate (CAN FD), Ethernet, local interconnect network (LIN), and FlexRay. The communication protocol may include other protocols for performing communication between various devices mounted on the vehicle. The external communication part may perform communication with other vehicles, an infrastructure system, a base station, or a roadside device by using various communication protocols. In this regard, the external communication protocol may include vehicle-to-everything (V2X) communication, including vehicle-to-vehicle (V2V) communication, vehicle-to-infrastructure (V2I) communication, vehicle-to-network (V2N) communication, and vehicle-to-pedestrian (V2P) communication. The infrastructure may be, for example, a roadside unit or server that periodically transmits traffic information in conjunction with a transportation information system (TIS) or an intelligent transport system (ITS).

The sensor 1120 may sense the state of the vehicle 11 and an external object. To sense the state of the vehicle 11, the sensor 1120 may include at least one of an inertial measurement unit (IMU), a distance measuring instrument (DMI), a collision sensor, a wheel sensor, a speed sensor, an inclination sensor, a weight detection sensor, a heading sensor, a position module, a vehicle forward/reverse sensor, a battery sensor, a fuel sensor, a tire sensor, a steering sensor, a temperature sensor, a humidity sensor, an ultrasonic sensor, an illuminance sensor, and a pedal position sensor. On the other hand, the IMU sensor may include one or more of an acceleration sensor, a gyro sensor, and a magnetic sensor. The sensor 1120 may generate state data of the vehicle, based on a signal generated from at least one sensor. For example, direction information such as the heading and yaw rate of the vehicle 11 may be collected by the sensor 1120.

To sense the external object, the sensor 1120 may include at least one of a camera, a radar sensor, a light detection and ranging (LiDAR) sensor, an ultrasonic sensor, and an infrared sensor. The sensor 1120 may measure at least one of information about the presence or absence of an object, information about the position of an object, information about the distance between the vehicle 11 and an object, and information about the relative speed between the vehicle 11 and an object.

The positioning device 1130 may generate position data of the vehicle 11. The positioning device 1130 may include at least one of a global positioning system (GPS), a differential global positioning system (DGPS), or a global navigation satellite system (GNSS). The positioning device 1130 may generate the position data of the vehicle 11 based on a signal generated from at least one of the GPS, the DGPS, or the GNSS. The positioning device 1130 may estimate the position of the vehicle 11 based on wireless signals received from the communication module 1110. The positioning device 1130 may estimate the current position of the vehicle 11 based on the previous position, travel distance information, moving time information, speed information, or acceleration information of the vehicle 11, by using the IMU or DMI. Meanwhile, the controller 1180 may estimate the path history and path prediction of the vehicle 11 based on the position information of the vehicle 11 collected by the positioning device 1130.

The operation device 1140 receives a user input for driving. In a manual mode, the vehicle 11 may be driven based on a signal provided by the operation device 1140. The operation device 1140 may include a steering input device such as a steering wheel, an acceleration input device such as an accelerator pedal, and a brake input device such as a brake pedal.

The driving controller 1150 is a device that electrically controls various vehicle driving devices in the vehicle 11. The driving controller 1150 may include a power train driving control device, a chassis driving control device, a door/window driving control device, a safety device driving control device, a lamp driving control device, and an air conditioning driving control device. The driving controller 1150 controls the movement of the vehicle 11 based on the input signal of the operation device 1140 or the control signal of the controller 1180.

The HMI 1160 is a device for communication between the vehicle 11 and a human (e.g., an occupant of the vehicle 11 or another vehicle). The HMI 1160 may receive a user input and provide information generated in the vehicle 11 to the user. The vehicle 11 may implement a user interface (UI) or user experience (UX) through the HMI 1160. The HMI 1160 may include an input device such as a touch panel or a microphone, and the HMI 1160 may include an output device such as a display device or a speaker. For example, the HMI 1160 may include an interior display that outputs a screen toward the inside of the vehicle and/or an exterior display that outputs a screen toward the outside of the vehicle.

The storage 1170 may store a program that causes the controller 1180 to perform a method according to an exemplary embodiment of the present disclosure. For example, the program may include a plurality of instructions executable by the processor, and the method according to at least an exemplary embodiment of the present disclosure may be performed by executing the plurality of instructions by the processor.

The storage 1170 may be a single memory or a plurality of memories. When the storage 1170 is formed of the plurality of memories, the plurality of memories may be physically separated. The storage 1170 may include at least one of a volatile memory and a non-volatile memory. The volatile memory includes a static random access memory (SRAM) or a dynamic random access memory (DRAM), while the non-volatile memory includes a flash memory.

The storage 1170 may store map information. The map information may be a navigation map and/or a high definition map (HD map). The HD map may be received from an external device or stored in advance. The navigation map includes a node indicating a point where at least two roads meet and a link connecting two nodes. The navigation map may include geographic information, road information, lane information, building information, or signal information. The HD map incorporates more specific data compared to the navigation map. The ADAS map may include road gradient, road curvature, or sign information, based on a road. The HD map may include lane information, lane boundary information, stop line position, traffic light position, signal sequence, or intersection information, based on a lane. The HD map may include basic road information, surrounding environment information, detailed road environment information, or dynamic road condition information. The detailed road environment information may include static information such as elevation of terrain, curvature, lane, lane centerline, regulation line, road boundary, road centerline, traffic sign, road surface sign, shape and height of the road, lane width, and the like. The dynamic road condition information may include traffic congestion, an accident section, a construction section, and the like. The HD map may include road surrounding environment information implemented in 3D, geometric information such as road shape or facility structure, and semantic information such as traffic signs or lane marks.

The controller 1180 may include at least one core capable of executing at least one instructions. The controller 1180 may execute the instructions stored in the storage 670. The controller 1180 may be a single processor or a plurality of processors. The controller 1180 may include the speech processing device 120 and the driver assistance system 140 shown in FIG. 1 structurally and/or functionally.

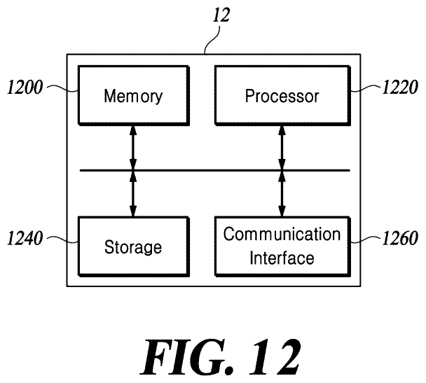

FIG. 12 is a schematic diagram of an illustrative configuration of a computing device that may be used to implement the methods and apparatuses described herein.

The computing device 12 may include some or all of a memory 1200, a processor 1220, a storage 1240, and a communication interface 1260.

The computing device 12 may structurally and/or functionally include at least a portion of the speech processing device 120, the driver assistance system 140, and/or the controller 1180. The computing device 12 may also include any specialized hardware accelerator capable of efficiently processing computations on AI models. For example, the computing device 12 may include a graphics processing unit (GPU), a tensor processing unit (TPU), or a neural processing unit (NPU).

The memory 1200 may store a program that allows the processor 1220 to perform methods or operations under various embodiments of the present disclosure. For example, the program may include a plurality of instructions executable by the processor 1220, and the plurality of instructions may be executed by the processor 1220 to perform the methods or operations illustrated in FIG. 7, FIG. 8, FIG. 9 and FIG. 10. The memory 1200 may be a single memory or a plurality of memories. In this case, information required to perform methods or operations according to various embodiments of the present disclosure may be stored in the single memory or divided and stored in the plurality of memories. When the memory 1200 is configured of the plurality of memories, the plurality of memories may be physically separated. The memory 1200 may include at least one of a volatile memory and a non-volatile memory. The volatile memory includes static random access memory (SRAM), dynamic random access memory (DRAM), or the like, and the non-volatile memory includes a flash memory.

The processor 1220 may include at least one core capable of executing at least one set of instructions. The processor 1220 may execute instructions stored in the memory 1200. The processor 1220 may be a single processor or a plurality of processors.

The storage 1240 maintains stored data even when power supplied to the computing device 12 is cut off. For example, the storage 1240 may include a non-volatile memory or may include a storage medium such as magnetic tape, optical disk, or magnetic disk. A program stored in the storage 1240 may be loaded into the memory 1200 before being executed by the processor 1220. The storage 1240 may store files created in a program language, and a program created from a file by a compiler or the like may be loaded into the memory 1200. The storage 1240 may store data to be processed by the processor 1220 and/or data processed by the processor 1220.

The communication interface 1260 may provide access to external devices. The computing device 12 may communicate with other devices via the communication interface 1260. The other devices are for example, components of the vehicle 10 shown in FIG. 1 or components of the vehicle 11 shown in FIG. 11.

Each of the elements of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application-specific integrated circuits (ASICs), computer hardware, firmware, software, and/or combinations thereof. The various embodiments can include implementation with one or more computer programs that are executable on a programmable system. The programmable system includes at least one programmable processor, which may be a special-purpose processor or a general-purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations in the flowcharts/timing charts are described in the present specification as being sequentially performed, they are merely an exemplary description of the technical idea of various exemplary embodiments of the present disclosure. In other words, those skilled in the art to which embodiments of the present disclosure belongs may appreciate that various modifications and changes can be made without departing from essential features of embodiments of the present disclosure, that is, the sequences described in the flowcharts/timing charts can be changed and one or more operations can be performed in parallel. Thus, the flowcharts/timing charts are not limited to the temporal order.

Embodiments of the present disclosure can dynamically output multiple audio streams generated in different domains in the vehicle by taking into account the driving situation of the vehicle.

According to embodiments of the present disclosure, conflicts between a speech response to a user request and another domain's audio output can be avoided. Furthermore, various exemplary embodiments of the present disclosure can alternately output the speech response and another domain's audio output while preventing a user from losing the context of the speech response.

According to embodiments of the present disclosure, outputting a natural language response generated by using generative artificial intelligence in the form of speech can be prevented from interfering with the output of audio that has a higher priority than the response.

According to embodiments of the present disclosure, a user can listen to the content of the speech response in understandable chunks while simultaneously listening to audio from another domain that has a higher priority at a time point distinct from the speech response.

Embodiments of the present disclosure can enable the use of generative AI by user inside the vehicle by providing effective responses despite the spatial constraints of a confined interior and the activity constraints of driving the vehicle. For example, the generative AI response can be provided in a way that does not interfere with the voice prompts on driving outputted by the GNSS navigator, which is highly beneficial to the driver.

The features of the present disclosure are not limited to those mentioned above, and other features not mentioned will be apparent to those of ordinary skill in the art from the above description.

Although exemplary embodiments of the present disclosure have been described for illustrative purposes, those skilled in the art will appreciate that various modifications, additions, and substitutions are possible without departing from the idea and scope of the claimed invention. Therefore, various exemplary embodiments of the present disclosure have been described for the sake of brevity and clarity. The scope of the technical idea of the embodiments of the present disclosure is not limited by the illustrations. Accordingly, one of ordinary skill would understand that the scope of the claimed invention is not to be limited by the above explicitly described embodiments but by the claims and equivalents thereof.

What is claimed is:

1. A method comprising:
dividing, by at least one processor, a text script or a first audio into multiple chunks based on a first time point at which a playback of the first audio is to start, a second time point at which a playback of a second audio is to start, or a combination of the first time point and the second time point, wherein the first audio is audio synthesized or to be synthesized based on the text script and the second audio has a higher priority than the first audio; and
non-consecutively outputting, by the at least one processor, speech signals corresponding to the multiple chunks, so that first playback time ranges corresponding to the multiple chunks do not overlap with a second playback time range of the second audio.

2. The method of claim 1, wherein the dividing of the text script or the first audio comprises:
determining a boundary between the multiple chunks based on grammatical markers that distinguish one or more semantic elements of the text script or one or more syntactic elements of the text script.

3. The method of claim 2, wherein the grammatical markers comprise:
punctuation, connective endings, or connectives.

4. The method of claim 2, wherein the dividing of the text script or the first audio comprises:
dividing the text script into a plurality of first candidate text chunks, each comprising a sentence or a clause;
determining a target text chunk corresponding to the second time point from among the plurality of first candidate text chunks;
dividing the target text chunk into a plurality of second candidate text chunks, each comprising a clause or phrase; and
generating the multiple chunks by grouping the plurality of first candidate text chunks excluding the target text chunk, and the plurality of second candidate text chunks, based on the second time point.

5. The method of claim 2, wherein the dividing of the text script or the first audio comprises:
restructuring a sentence structure of the text script so that the grammatical markers are placed within a restructured text script at locations corresponding to the second time point.

6. The method of claim 1, further comprising:
restructuring, by the at least one processor, the text script to include a summary of content recently played from the first audio and a content that has not yet been played in the first audio, in response to an occurrence of a third audio that needs to be played immediately; and
outputting, by the at least one processor, a speech signal corresponding to a restructured text script in response to an end of playback of the third audio.

7. The method of claim 1, wherein the multiple chunks comprise:
a first chunk to be played before the second audio; and
a second chunk to be played after the second audio.

8. The method of claim 7, wherein the non-consecutively outputting of the speech signals further comprises:
outputting one or more bridge audios indicating that the second chunk is to be played after the second audio, at a time distinct from the second playback time range of the second audio.

9. The method of claim 7, further comprising:
determining, by the at least one processor, a third time point at which a playback of the second chunk is to start, based on the first time point, the second time point, and a duration of the second audio.

10. The method of claim 9, wherein the third time point is a fourth time point at which playback of the second audio is predicted to end, plus a delay of a predetermined margin time.

11. The method of claim 10, wherein the first audio and the second audio are audio outputs to an interior of a vehicle, and
wherein the predetermined margin time is dynamically determined based on a speed of the vehicle.

12. The method of claim 10, wherein the first audio and the second audio are audio outputs to an interior of the vehicle, and
wherein the predetermined margin time is dynamically determined based on whether the vehicle is stopped and a fifth time point at which the vehicle is predicted to resume traveling.

13. The method of claim 1, wherein the first audio and the second audio are audio outputs to an interior of a vehicle, and
wherein the non-consecutively outputting of the speech signals comprises:
determining, based on a change in a speed of the vehicle, whether the text script or the first audio needs to be re-divided.

14. The method of claim 13, further comprising:
adaptively re-dividing, by the at least one processor, the text script or the first audio based on an updated second time point that is updated in real time as the vehicle travels.

15. The method of claim 14, wherein the text script comprises:
one or more first level grammatical markers, indicating boundaries between different sentences; and
one or more second level grammatical markers, indicating boundaries between different sentence elements within a single sentence, and
wherein the dividing of the text script or the first audio comprises:
determining a dividing point in the text script or the first audio by hierarchically searching the one or more first level grammatical markers and the one or more second level grammatical markers.

16. The method of claim 15, wherein the adaptively re-dividing of the text script or the first audio comprises:
determining which of the one or more first level grammatical markers and the one or more second level grammatical markers to begin searching, based on whether playback has already begun for at least some of the multiple chunks.

17. The method of claim 15, the text script further comprises:
one or more third level grammatical markers, linking different syntactic elements within a single sentence element, and
wherein the adaptively re-dividing of the text script or the first audio comprises:
determining, from among divided chunks, a target chunk having the second playback time range that overlaps with the second audio; and
determining a re-dividing point in the text script or the first audio by hierarchically searching the one or more second level grammatical markers and the one or more third level grammatical markers within the target chunk.

18. The method of claim 1, wherein the text script is generated by a language model in response to a user's query, and
wherein the second audio comprises voice prompts to assist in driving a vehicle.

19. A device, comprising:
a memory storing instructions; and
at least one processor operatively connected to the memory,
wherein the at least one processor executing the instructions is configured:
to divide a text script or a first audio into multiple chunks based on a first time point at which a playback of the first audio is to start, a second time point at which a playback of a second audio is to start, or a combination of the first time point and the second time point, wherein the first audio is audio synthesized or to be synthesized based on the text script and the second audio has a higher priority than the first audio; and
to non-consecutively output speech signals corresponding to the multiple chunks, so that first playback time ranges corresponding to the multiple chunks does not overlap with a second playback time range of the second audio.

20. A vehicle, comprising:
a driver assistance system configured to generate a first audio for assisting a driver, or a first text script for synthesizing the first audio; and
a speech processing device including at least one processor and configured:
to divide a second text script or a second audio into multiple chunks based on a first time point at which a playback of the first audio is to start, a second time point at which a playback of the second audio is to start, or a combination of the first time point and the second time point, wherein the second audio is audio synthesized or to be synthesized based on the second text script and has a lower priority than the first audio, and
to non-consecutively output speech signals corresponding to the multiple chunks, so that second playback time ranges corresponding to the multiple chunks does not overlap with a first playback time slot of the first audio.
